(19) United States
(12) Patent Application Publication
(10) Pub. No.: US 2026/0260514 A1
(43) Pub. Date: Sep. 3, 2026

(54) ENHANCED AGENT SELECTION BASED ON USER PREFERENCES AND HISTORICAL INTERACTION DATA

(71) Applicant: Voicify Ninja LLC, Needham, MA (US)

(72) Inventors: Nick Laidlaw, Boston, MA (US); Jeff McMahon, Boston, MA (US); William Charles Clem, III, Nashville, TN (US)

(21) Appl. No.: 19/655,375

(22) Filed: Apr. 22, 2026

Related U.S. Application Data
(63) Continuation-in-part of application No. 18/490,694, filed on Oct. 19, 2023, now Pat. No. 12,641,181.
(60) Provisional application No. 63/423,794, filed on Nov. 8, 2022.

(51) Int. Cl. G06V 40/16; H04L 65/1069; H04L 67/306

(52) U.S. Cl. CPC G06V 40/172; H04L 65/1069; H04L 67/306

(57) ABSTRACT

Computerized systems and methods are disclosed for dynamically allocating interaction resources within distributed interaction environments. An interaction station includes sensing devices that capture data associated with an approaching end user. One or more computing systems process the sensor data to detect identity features and retrieve historical interaction records associated with the end user. A resource allocation engine executes a prediction model to determine a preferred interaction modality based on historical interaction records and behavioral patterns. Based on the prediction, the system selects an interaction agent from a pool of available agent devices, including devices operated by human agents and automated agent processes executed by computing systems. A communication session is established between the interaction station and the selected agent device, and contextual information derived from historical interaction records is synchronized to display devices associated with the interaction station and the selected agent.

### CROSS REFERENCE TO RELATED APPLICATION

This patent application claims priority to, and the benefit of, U.S. Patent Application No. 18/490,694 filed October 19, 2023, entitled “SHARED RESOURCE ALLOCATION FOR MULTIPLE QUEUE PROCESSING,” which also claims priority to, and the benefit of, U.S. Provisional Patent Application Serial No. 63/423,794 filed November 8, 2022, entitled “SHARED RESOURCE ALLOCATION FOR MULTIPLE QUEUE PROCESSING,” which is hereby incorporated in its entirety by reference.

### BACKGROUND

Many environments deploy electronic interaction stations that allow end users to interact with a remote system through audio, visual, or graphical interfaces. Examples of such environments include drive-through interaction stations, counter-mounted kiosks, interactive terminals, and similar computing devices positioned at locations where an end user approaches a station to initiate an interaction. These stations typically include components such as microphones, speakers, displays, cameras, and network interfaces that enable communication between the station and a remote computing system or remote agent device. In many implementations, a drive-through interaction station connects an end user located at the station to a remotely located human agent through a network communication system. In other implementations, the interaction station presents a graphical interface that allows the end user to interact directly with a kiosk application executing on a local or remote computing system.

Although such systems are widely deployed, conventional implementations frequently suffer from inefficient utilization of available computing and human resources. For example, many drive-through interaction systems rely on a dedicated human operator assigned to a specific location. In such systems, the human operator remains assigned to that location even during periods in which no end user is present at the interaction station. As a result, human operator time may be underutilized when stations experience intermittent usage patterns. Conversely, when multiple end users arrive at stations simultaneously, the system may lack mechanisms for dynamically allocating additional operators from a shared pool of available agents. Similarly, many existing systems lack mechanisms for selecting between multiple types of available agents, such as human-operated agents and automated software agents, in response to detected characteristics of the end user interacting with the station.

Another limitation arises from the limited integration between sensing systems deployed at interaction stations and systems responsible for allocating remote interaction resources. Modern interaction stations may include cameras or other sensors capable of detecting features of an approaching end user or a vehicle associated with the end user. However, conventional systems typically do not use such sensor-derived information to influence the selection of an appropriate agent or interaction modality.

Counter-mounted kiosk systems present a different set of technical limitations. In many implementations, kiosk interfaces rely on touch-screen interactions that require end users to navigate through multiple hierarchical menu structures or graphical screens. Such interfaces often require significant manual interaction with the display surface and may involve numerous sequential inputs to complete an interaction. These kiosk systems may therefore introduce latency and usability challenges, particularly in situations where the interface requires extensive navigation or when the end user is unfamiliar with the interface layout. Additionally, kiosk interfaces may not adapt dynamically to the behavioral patterns or preferences of individual end users, resulting in repeated presentation of generic interface elements that may not correspond to the end user’s typical interaction patterns. Furthermore, conventional interaction systems generally operate without leveraging historical interaction data to optimize future interactions. Even when historical data exists, such as records of previous interactions associated with a particular end user, the information may not be available to the system at the time the interaction begins. As a result, the system may fail to adjust the interaction process based on known characteristics of the end user.

Another limitation of existing systems is that they typically lack mechanisms for predicting interaction preferences of previously unseen end users based on aggregated behavioral patterns. For example, systems generally do not analyze patterns associated with groups of users located in a common geographic region or sharing similar behavioral characteristics to predict whether a newly detected end user is more likely to prefer interaction with a human-operated agent or an automated software agent. As a consequence of these limitations, existing interaction systems frequently experience inefficient allocation of computing resources, inefficient utilization of human operators, and interaction interfaces that may be cumbersome or time-consuming for end users to navigate.

### SUMMARY

The techniques disclosed herein describe computerized systems for dynamically allocating interaction resources across a distributed network of interaction stations and agent devices. The system includes one or more sensing devices positioned at interaction stations, one or more computing systems configured to process sensor-derived data associated with an approaching end user, and a resource allocation engine configured to select an interaction agent from a pool of available agents. The agents may include human-operated devices or automated software agents executing on remote computing systems. The resource allocation engine evaluates sensor-derived identity data, historical interaction records, and predicted behavioral patterns to determine an agent assignment and to establish a communication session between the interaction station and the selected agent device. In various embodiments, the system further synchronizes contextual information across multiple computing devices participating in the interaction, including display devices at the interaction station and computing devices associated with the selected agent.

In some embodiments, the resource allocation engine selects a computing device operated by a human agent from the pool of available agent devices based on a comparison between attributes associated with the detected end user and attributes associated with profiles of the human agents. The attributes associated with the detected end user may be derived from historical interaction records and may include language preferences, interaction duration metrics, prior interaction outcomes, or other characteristics associated with previous interaction sessions. The attributes associated with the human agents may include language capabilities, training characteristics, behavioral interaction traits, or historical performance metrics. The resource allocation engine may determine compatibility between the attributes associated with the end user and the attributes associated with one or more human agents and may select a human agent device associated with an agent whose profile most closely corresponds to the derived characteristics.

In certain embodiments, the system further prioritizes selection of a human agent when historical interaction records indicate that the detected end user previously interacted successfully with a particular human agent or with agents having similar characteristics. The system may evaluate performance metrics associated with prior interaction sessions, including interaction duration, interaction completion rates, or other system-defined efficiency measures. Based on these metrics, the resource allocation engine may select a human-operated agent device and establish a real-time communication session between the interaction station and the computing device associated with the selected human agent. In this manner, the system can dynamically connect an interaction station to a remotely located human agent through a network communication channel when historical data indicates that human-mediated interaction is likely to produce efficient interaction outcomes.

In other embodiments, the resource allocation engine may select an automated agent process executed by one or more computing systems when the prediction model determines that an automated interaction modality is appropriate for the detected end user. The automated agent process may be implemented as a software agent executing on one or more computing devices connected to the distributed interaction system and may be located at any computing environment accessible through the network. The automated agent process may be configured to receive audio or other input data from the interaction station, process the input data using one or more artificial intelligence models, and generate responses transmitted to the interaction station through the communication session established by the system.

In certain implementations, the system may dynamically transition between automated agent processes and human-operated agent devices during an interaction session. For example, the automated agent process may initially interact with the end user and evaluate characteristics of the interaction, such as confidence levels associated with automated responses or detected characteristics of the input data. When predetermined conditions are detected, the system may establish a communication session with a human-operated agent device and transfer the interaction session to the selected human agent. This dynamic allocation of interaction resources allows the distributed computing system to balance automated processing capabilities with human-operated agent devices to improve utilization of available interaction resources.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an example architecture of a system in which remote agents communicate with stations located at different organizations through a portal system and an agent pool.

FIG. 2A illustrates an example queue environment including stations having microphones, speakers, and displays that enable communication between users and remote agents.

FIG. 2B illustrates a communication system connecting stations at a queue to remote agents while presenting menu information to users.

FIG. 2C illustrates sensors and cameras positioned to detect user presence and movement within a queue environment.

FIG. 2D illustrates an example user interface presenting menu options and suggestions to a user.

FIG. 2E illustrates an example interface in which a live rendering of an agent is presented while menu options remain available.

FIG. 2F illustrates another example menu interface including selectable menu items.

FIG. 3 illustrates a queue system including multiple stations, sensors, microphones, speakers, and a user queue.

FIG. 4 illustrates an example agent pool including agents having different training attributes for servicing different organizations.

FIG. 5A illustrates ranking agents within an agent pool and maintaining an on-deck list for servicing requests from stations.

FIG. 5B illustrates assigning candidate agents from the agent pool to service queues associated with selected organizations.

FIG. 5C illustrates detecting a user approaching a station and initiating preparation of candidate agents.

FIG. 5D illustrates updating the on-deck list based on queue activity and station availability.

FIG. 5E illustrates establishing a communication connection between a selected agent and a station through a portal connector.

FIG. 5F illustrates routing interaction data and transaction data between a user, an agent, and system servers while collecting performance statistics.

FIG. 6A illustrates determining candidate agents by evaluating training attributes associated with agents in the agent pool.

FIG. 6B illustrates sending availability requests to agents and receiving responses indicating availability.

FIG. 6C illustrates selecting a confirming agent from responding agents.

FIG. 7A illustrates sending availability requests to multiple agents in parallel.

FIG. 7B illustrates selecting the first confirming agent as an on-deck agent for a station.

FIG. 8A illustrates identifying a user using sensor and camera data prior to the user reaching a station.

FIG. 8B illustrates determining user attributes based on detected characteristics including vehicle attributes or other observable characteristics.

FIG. 8C illustrates generating predictions about user preferences based on detected characteristics and historical interaction data.

FIG. 9 illustrates generating predicted ordering preferences based on clusters of customers associated with geographic regions.

FIG. 10A illustrates selecting an agent type based on detected user preferences or predicted preferences.

FIG. 10B illustrates switching between an AI agent and a human agent based on user input or updated preference information.

FIG. 11A illustrates presenting historical transaction information associated with a detected user.

FIG. 11B illustrates displaying historical transaction information concurrently on both an agent device and a station display.

FIG. 12A illustrates detecting a user in a queue using multiple sensors positioned along the queue.

FIG. 12B illustrates identifying a user using video analysis including facial recognition or vehicle identification.

FIG. 12C illustrates selecting a preferred agent based on a user profile and stored preferences.

FIG. 12D illustrates connecting the station to the selected agent before the user reaches the station.

FIG. 13A illustrates example customer profiles used to store historical transaction data and preferences.

FIG. 13B illustrates example agent profiles including training attributes and performance metrics.

FIG. 13C illustrates matching users with agents based on preferences, historical interactions, and training attributes.

FIG. 14A illustrates an example user interface presented to a user at a station.

FIG. 14B illustrates a menu interface presented to an unrecognized user.

FIG. 14C illustrates a menu interface presented to a returning user based on historical interactions.

FIG. 15 illustrates an example interface presented on an agent device for interacting with a user and managing an order.

FIG. 16 illustrates a flow diagram of a routine for requesting availability from agents and connecting a confirming agent to a station.

FIG. 17 illustrates an example computing system architecture used to implement the described system.

FIG. 18 illustrates an example distributed computing environment including servers, devices, and network resources supporting the system.

### DETAILED DESCRIPTION

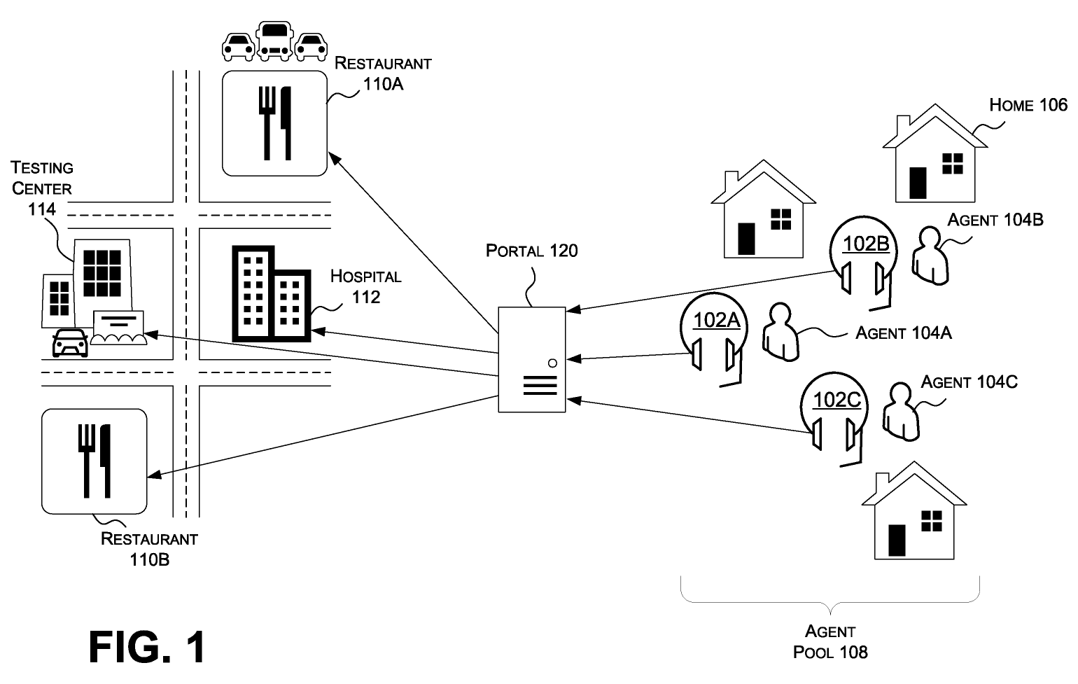

FIG. 1 illustrates an overview of a portal 120 allocating customer service agents 104 to customer service tasks at different organizations. For example, an agent 104 may communicate with a customer of restaurant 110A. In other examples, an agent 104 may communicate with a patient of healthcare facility 112, a subject of test center 114, etc. In some configurations, agents 104 work from home 106. Additionally, or alternatively, agents 104 may work in an office or any other location that is connected to the Internet. Agents 104 may use headsets 102 to communicate with users of the organizations via customer service stations located at the heads of queues at various locations of the organizations.

Restaurant 110A may have a drive-thru window. When a car approaches the ordering station of restaurant 110A, portal 120 will connect an available agent 104 to the ordering station. Similarly, restaurant 110B may have an indoor ordering station. When approached by a user, portal 120 may connect an available agent 104 that is trained to guide the user through the ordering and payment process of restaurant 110B. Organizations such as those depicted in FIG. 1 may have multiple locations around the world. Agents 104 are trained to perform customer service tasks for particular organizations, expanding the number of tasks that an individual agent 104 may perform.

The system provides live video and audio feeds of an agent to each customer station. The system can also provide live video and audio feeds of the customer back to an agent. The live video feeds of each agent provide more efficiency to an organization than a typical kiosk because the end user is able to make a visual and audio connection with an agent. Being able to see the face of the agent helps each end user, e.g., each customer, have a better customer service experience, and it also helps with the speed and accuracy of each order. Agents allow a user to ask questions, a feature that most kiosks may not be able to provide.

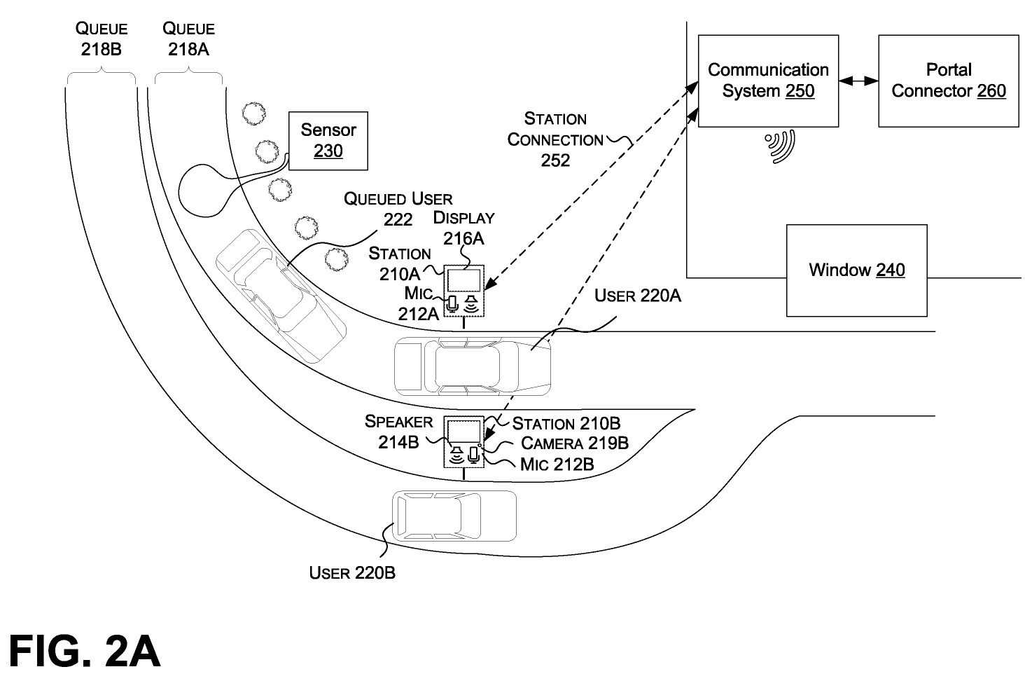

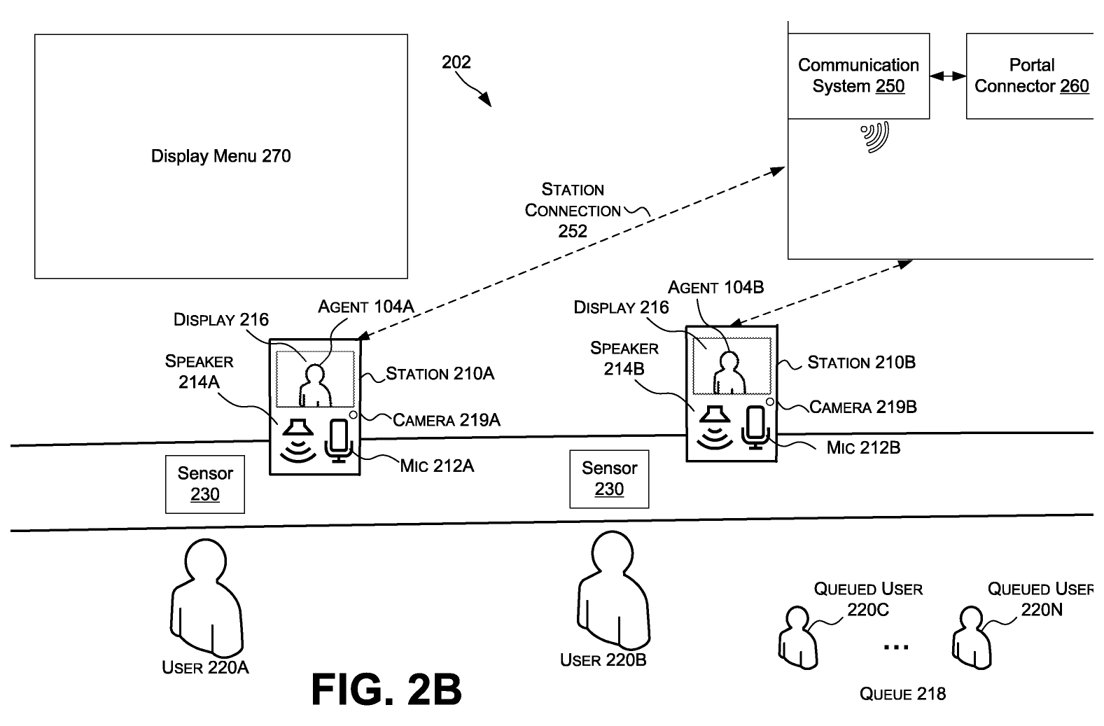

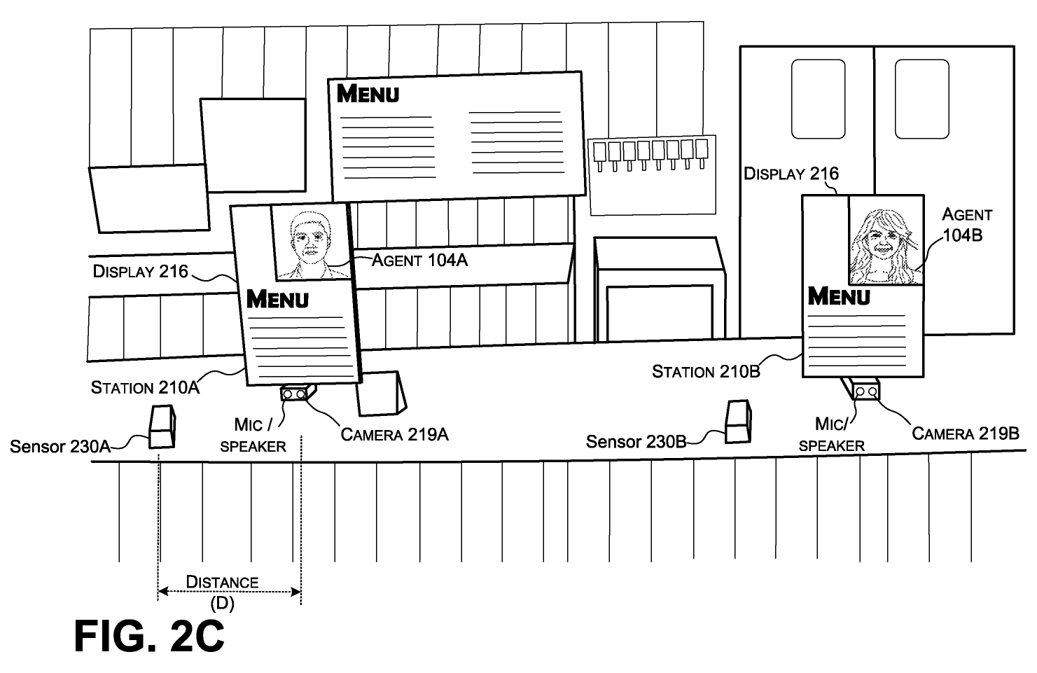

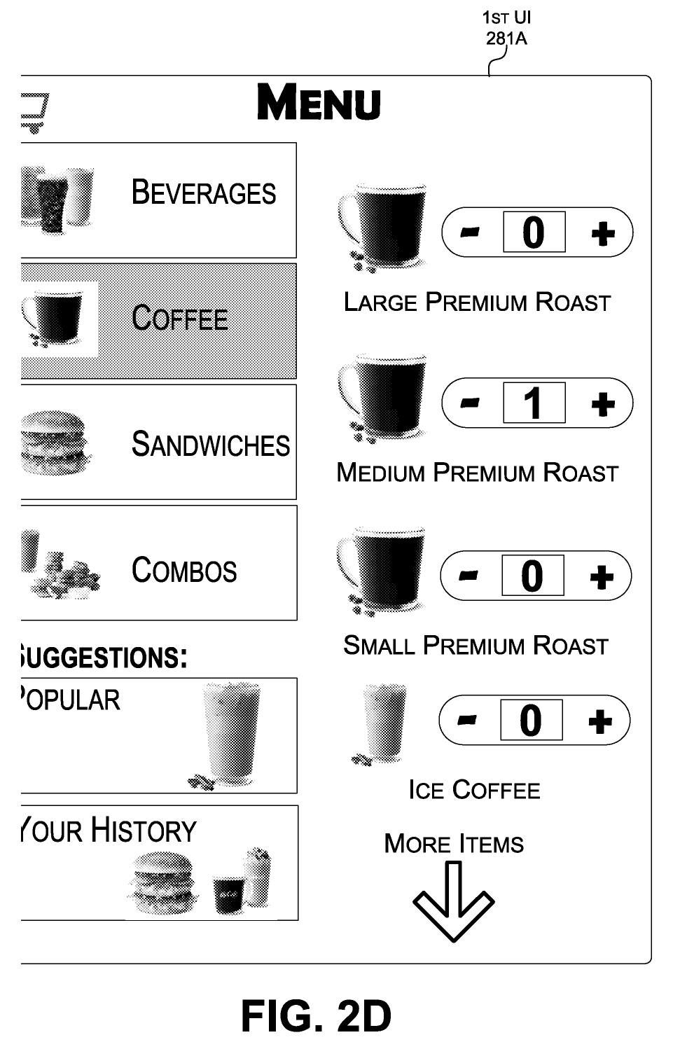

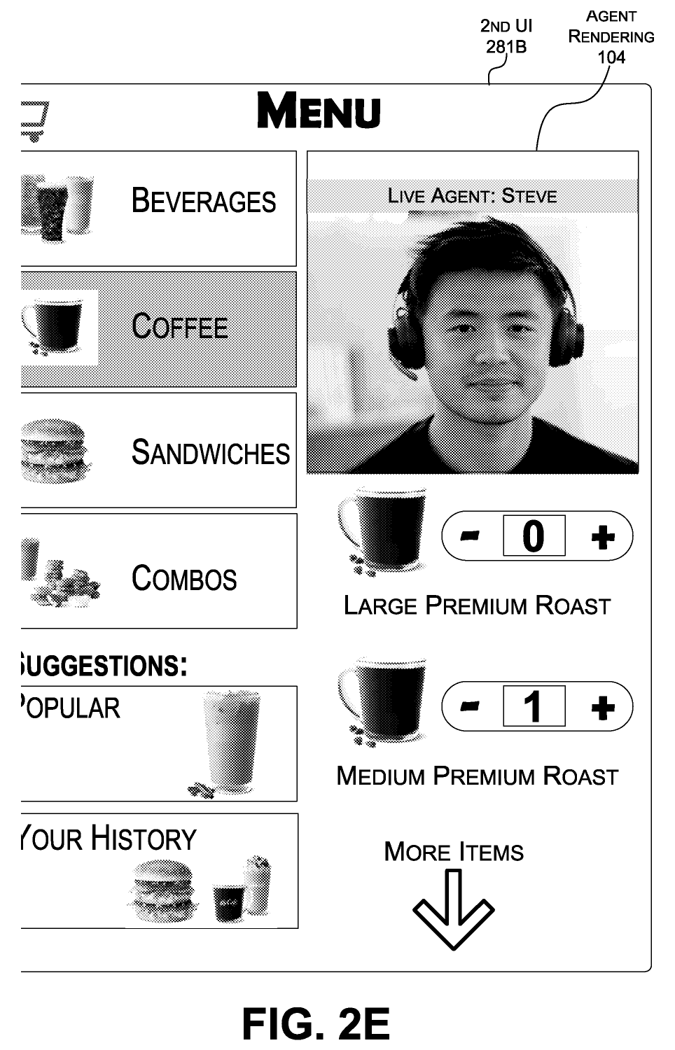

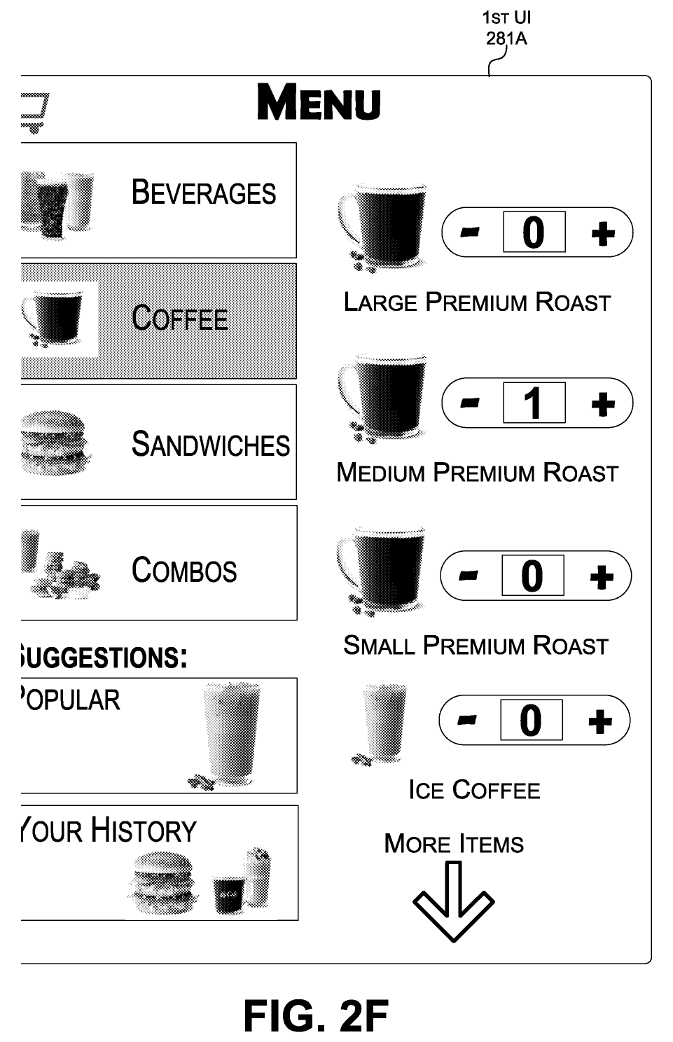

FIG. 2A illustrates a drive-through restaurant 110A in which ordering is handled by off-site agents 104. User 220 pulls up to station 210 of queue 218 that contains microphone 212, speaker 214, and display 216. User 220 may interact with station 210 to order food.

Upon pulling up to the front of an empty queue 218, user 220 is quickly connected with one of agents 104. For example, user 220 may use microphone 212 and speaker 214 to interact with the communication system 250. The communication system 250 is connected to an agent 104 via portal connector 260 and portal 120. In some configurations, portal connector 260 is a custom-made device that interoperates with the communication system 250. In this way, instead of transmitting the audio conversation with user 220 wirelessly to a headset within restaurant 110A, the audio conversation is transmitted over the Internet via portal connector 260 and portal 120 to agent 104. If agent 104 is connected quickly enough, e.g., in under 5 seconds, user 220 may not know that agent 104 is working remotely from restaurant 110A. In some configurations, if agent 104 is not available immediately when user 220 pulls up to station 210, a pre-recorded greeting may be played to indicate that someone will be there shortly.

User 220, as guided by agent 104, makes a selection which agent 104 enters into portal 120. When user 220 has completed their order, user 220 may provide a payment method such as a credit card to station 210. The credit card may be processed by portal 120 directly with a payment provider, i.e., without allowing any credit card information to be exposed to the computing device used by agent 104. Once the order has been paid for, as indicated by portal 120, agent 104 will instruct portal 120 to submit the order to restaurant 110A, where it may be filled and provided to user 220.

Quickly connecting user 220 with agent 104 is important to creating a satisfying user experience. In order to reduce the amount of time that user 220 must wait at station 210, sensors may be used to detect when user 220 is approaching the front of an empty queue 218. For example, sensor 230 is a loop sensor that detects a car passing over it. Once sensor 230 is triggered, portal 120 will indicate to the user for that organization that they will be connected and are to begin taking the order. If the amount of time it takes for agent 104 to connect to station 210 is at most the amount of time it takes for user 220 to proceed from sensor 230 to station 210, then agent 104 will appear to have been instantly available to user 220. Other sensor technologies are similarly contemplated, such as computer vision algorithms that detect an approaching user. A sensor may be positioned at a predetermined distance away from a station. This enables the system to detect a vehicle prior to their arrival at the station. This can reduce the amount of time a person has to wait at the station while the system selects a particular agent.

In some configurations, once an agent 104 is assigned to a queue 218, that agent 104 will remain assigned to the same queue until it is cleared, or until the agent 104 indicates that they need a break.

FIG. 2B illustrates the front counter configuration for a restaurant 202 in which ordering is handled by off-site agents 104. The end users 220 can approach a station 210 at the restaurant 202. The end users 220 can also form a queue 218 near each station. Each station can contain a microphone 212, a speaker 214, and a display screen 216. The end users 220 can interact a live video rendering of an agent 104 shown in the display screen of each station 210 to place an order. The agent can answer questions, explain the menu, and enter the order information for the end user.

As the end user reaches the front of the queue 218 and approaches a station 210, the system uses a proximity sensor to automatically connect the user 220 with an assigned agent 104. For example, a sensor 230 may be in the form of an infrared detector or a radio proximity sensor detecting an end user within a predetermined distance. Once a user 220A is detected, the system can activate a microphone 212A and speaker 214A to enable the user 220A to interact with communication system 250. The communication system 250 is connected to an agent 104 via portal connector 260 and portal 120 (FIG. 1). In some configurations, portal connector 260 is a custom-made device that interoperates with the communication system 250. In this way, instead of transmitting the audio conversation with user 220A wirelessly to a headset within the restaurant, the audio conversation is transmitted over the Internet via portal connector 260 and portal 120 to agent 104. If the agent 104 is connected quickly enough, e.g., in under 5 seconds, user 220 may not know that agent 104 is working remotely from restaurant 110A. In some configurations, if agent 104 is not available immediately when the user 220A walks up to station 210, a pre-recorded greeting may be played to indicate that the agent 220A will arrive shortly.

The user 220A, as guided by agent 104 in a conversation with the user 220A, makes a selection and the agent 104 enters the selections into the portal 120. When user 220A has completed their order, user 220A may provide a payment method such as a credit card to station 210A. The credit card may be processed by portal 120 directly with a payment provider, i.e., without allowing any credit card information to be exposed to the computing device used by agent 104. Once the order has been paid for, as indicated by portal 120, agent 104 will instruct portal 120 to submit the order to restaurant 110A, where it may be filled and provided to user 220.

Having a system that enables a quick connect between the end user 220 and the agent 104 is important to creating a satisfying user experience. In order to reduce the amount of time that user 220 must wait at station 210, sensors may be used to detect when user 220 is approaching the front of an empty queue 218. For in other examples, sensor 230 is a loop sensor that detects an approaching user. Once sensor 230 is triggered, portal 120 will indicate to the end user 220 that they will be connected to an agent.

In some embodiments, the position of the sensor can be at a predetermined distance from a station. For example, the sensor 230 can be positioned such that the amount of time for establishing a connection between the agent 104 and the station 210 less than the amount of time it takes for the user 220 to move from the sensor 230 to station 210. This will give the appearance that the agent 104 is instantly available as the user 220 approaches the counter. Other sensor technologies are similarly contemplated, such as computer vision algorithms that detect an approaching user. By placing the sensor at a predetermined distance away from the front counter station, the system can give the agent time to connect to the station prior to the arrival of the end user. This can reduce or eliminate the amount of time a person has to wait at the front counter station while the system selects a particular agent. This technique can also be used in the drive-thu embodiments as well.

In some configurations, once an agent 104 is assigned to a queue 218, that agent 104 will remain assigned to the same queue until it is cleared, or until the agent 104 indicates that they need a break. Similar to the other embodiments disclosed herein, the system can remove agents from a queue in response to the detection of one or more events. Agents are re-assigned to a queue in response the detection of an end user by one or more sensors.

FIG. 2C illustrates a perspective drawing of a restaurant having stations used for a counter queue that can be staffed by off-site agents. This figure shows how the rendering of the agents on a display screen 216 can be directed toward the front of a counter, allowing the station to replace an in-person agent. This allows customers to approach a counter and place an order in a traditional manner. Each station 210 is positioned at a predetermined distance from each corresponding sensor 230.

In this example, each sensor is positioned on the left side of the station. This configuration can be used in a scenario where a queue of customers is located on the left side fo the station. Thus, as customers approach the station from the left, the sensor detects the presence of the customer at a first time (T₁) prior to a second time (T₂) at which the customer is standing in front of the camera 219 of the station. The position of each sensor 230 can be such that the difference between the first time (T₁) and the second time (T₂) is greater than a threshold time (Tₜₕ). The threshold time can be based on a number of agents in a pool and/or a performance metric of agents in a pool. For instance, if a pool typically has a first number available agents and a first average response time for responding to a customer notification, the sensor can be set a first distance (D₁). However, if the pool typically has a second number available agents and a second average response time for responding to a customer notification, the sensor can be set a second distance (D₂) that is greater than the first distance (D₁) if the second number available agents is less than the first number of available agents and/or the second average response time is greater than the first average response time.

Turning now to FIGS. 2D-2F, embodiments for controlling user interface arrangements displayed at a station are shown and described below. In some configurations, the system can display different types of user interface arrangements in response to the detection of one or more predetermined events. A first user interface arrangement can include a standard kiosk format having a list of menu items, an interaction tools for allowing a user to select menu items, and shopping cart features for allowing a user to purchase the items. A second user interface arrangement can include one or more features of the kiosk format but also include a live video feed of an agent for assisting a user at the station. The live video feed can be a one-way feed for allowing the user to view the agent, or the live video feed can be a two-way feed for also allowing the agent to view the user for understanding context. In either embodiment, the station can also include a camera for detecting gestures of the user.

In one illustrative example, as shown in FIG. 2D, a display screen 216 of a counter station 210 can default to a standard ordering kiosk format. In this first user interface arrangement 281A, the display can include a number of item categories and/or specific items that a user can select. When specific item categories are selected, the system can display items within a particular category. In this example, a coffee category is selected and individual coffee options are displayed with an input tool for selecting a quantity of each item. In addition, the first user interface arrangement can allow a user to select individual item and allow that person to check out using a shopping cart tool. When selected, the shopping cart tool can include a list of selected items and functionality to enable a transaction for the purchase of the selected items.

When the system detects one or more predetermined events, the system can transition from the first user interface arrangement to a second user interface arrangement. An example of the second user interface arrangement 281B is shown in FIG. 2E. In this embodiment, the second user interface arrangement can include a rendering 104 of a live video feed of an agent who can assist the user in placing an order. The live video feed can be accompanied by a bidirectional live audio feed between the user and the agent. The system can also enable permissions for the agent to update the user's shopping cart. This allows the user to ask questions about the menu, confirm order selections, and allow the agent to provide an input causing the system to update the shopping cart of newly selected items on the user's behalf. When the user indicates that they no longer need assistance, which can be a user interface input or a voice input, the system can remove the live video feed of the agent, disconnect the audio connection, and disable permissions for the agent to modify the user's shopping cart. When the agent is disconnected from the station, the system changes the permissions so that the selected agent is restricted from modifying the user’s cart for that particular station. When the live video feed is disabled, the system can cause the display of the first user interface arrangement 281A, as shown in FIG. 2F.

The detection of one or more predetermined events can include interactions between a user, e.g., a customer, and a station. For example, if a user has difficulty ordering, the system can generate one or more notifications for an agent to connect to the station. The agent can be selected using any of the techniques discussed herein. The agent can be connected via live video and audio connections so they can have a conversation with the user at the station. In some embodiments, the predetermined events can be a detected pause for selections for more than a predetermined period of time. If a person takes more than the predetermined period of time without providing an input, the system can notify an agent and then cause a connection between the station and the agent computer. The predetermined events can also be a number of corrections to an order, e.g., when a user deletes a threshold number of items and/or replaces a threshold number of items. In the detection of such events, the system can notify an agent, connect the agent and change permission for that agent to modify a shopping cart for the associated user.

In some embodiments, the predetermined events can also be one or more predetermined gestures captured by a camera or microphone of the station. The predetermined gestures can include an expression showing confusion, frustration, etc. Images of the user, e.g., video frames, can be communicated to a generative pretrained transformer model with a prompt asking for a text description of an expression. In one example, if the model returns a description indicating frustration or confusion, and a confidence score of that indication is over a threshold value, the system can detect a predetermined event and initiate a notification for, and a connection with, an agent. Text transcriptions of the user’s speech can also be communicated to a generative pretrained transformer model with a prompt asking for a text description of an expression. In one example, if the model returns a description indicating frustration or confusion from the user’s speech, and a confidence score of that indication is over a threshold value, the system can detect a predetermined event and initiate a notification for, and a connection with, an agent. The confidence score can be returned from the model by the use of a prompt sent with the speech input or the video input, where the prompt can explicitly request for a mood or expression of the input and a confidence score of a determined mood or expression.

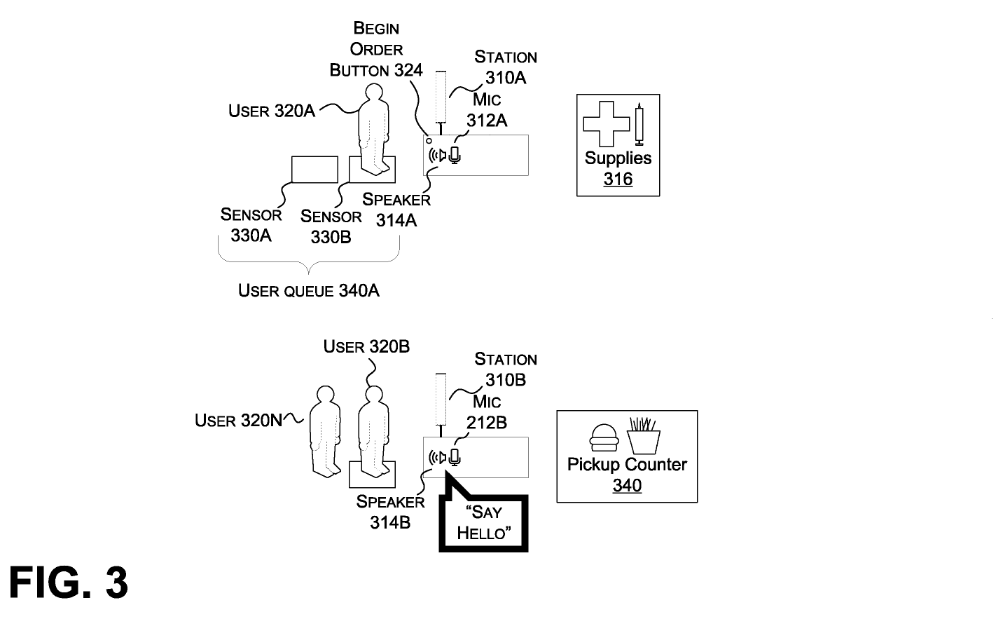

FIG. 3 illustrates another example of how stations can be configured in a restaurant 110B staffed by off-site agents 104. This example shows how pressure sensors on the floor can be used to detect the movement and position of end users in a queue. Similar to an optical or sonar-based sensor, multiple floor sensors can detect a rate in which a queue is moving. Based on the rate in which a customer is moving through a queue, the system can change the timing at which an agent is notified or connected to a station. Users 320 may form a line in user queue 340. The head of user queue 340 is approximate to station 310, which uses microphone 312 and speaker 314 to communicate with one of agents 104. In some configurations, a sensor 330 is used to detect an approaching user 320. This allows enough lead time for the agent 104 to connect and begin taking the order. Additionally, or alternatively, begin order button 324 may be pressed by user 320 to initiate an ordering session. Other techniques for beginning an order are similarly contemplated, including voice activation using mic 312, optionally in response to a voice prompt generated by speaker 314. In some configurations, once an agent 104 is connected to a station 310 of a queue 340, then that same agent 104 remains connected to station 310 until the queue 340 is cleared. For example, if user 320B completes their order and leaves Q340B, user 320C may approach station 310B and begin their order with the same agent 104 that helped user 320B.

Pick up counter 340 illustrates the result of an order that has been submitted and prepared. While the example of a restaurant is used predominantly throughout this application, other embodiments are similarly contemplated, such as administering a medical test. In this scenario, user 320 is a patient who wants to know if they have a particular condition. Agent 104 may guide user 320 through the testing process. In this scenario, supplies 316 may include a test kit.

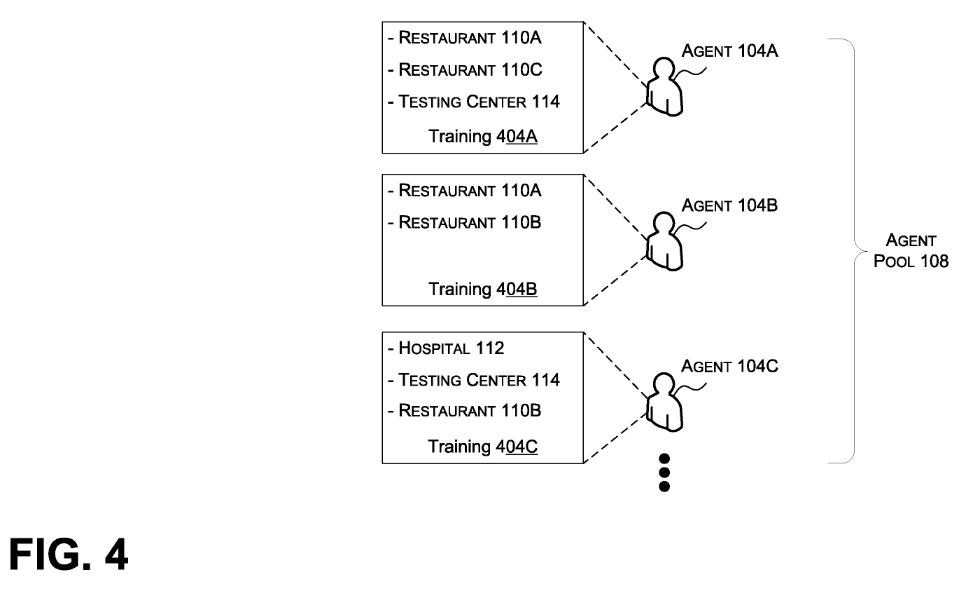

FIG. 4 illustrates training records 304 of different agents 104. Each agent 104 of agent pool 108 may be represented by a record in a database. Training records 304 list which organizations a particular agent 104 has been trained to work with. As illustrated, training 304A indicates that agent 104A is certified to work with restaurant 110A, restaurant 110C, and testing center 114. Similarly, agent 104B is certified to work with restaurant 110A and restaurant 110B, while agent 104C is certified to work with hospital 112, testing center 114, and restaurant 110B.

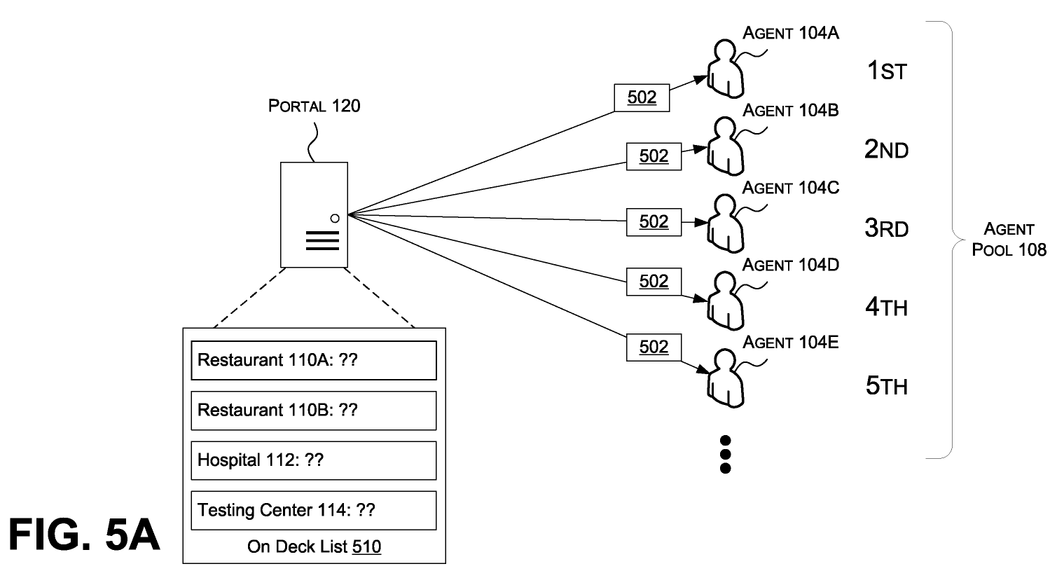

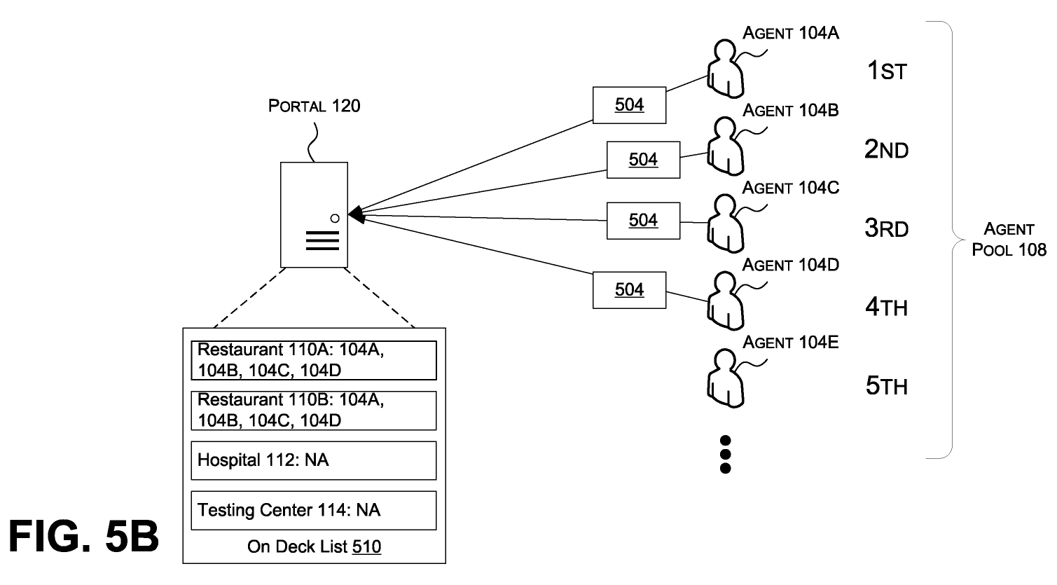

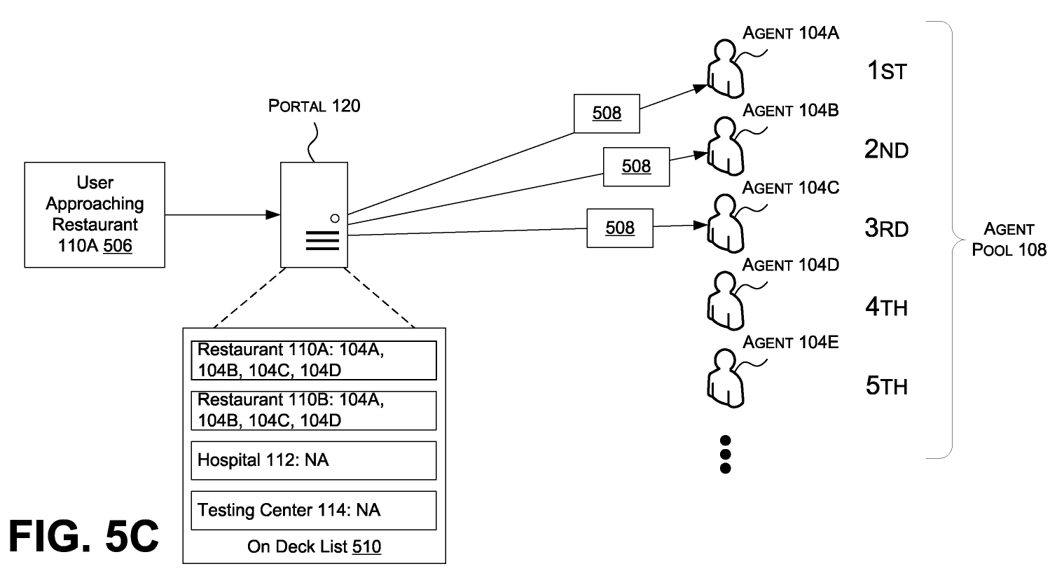

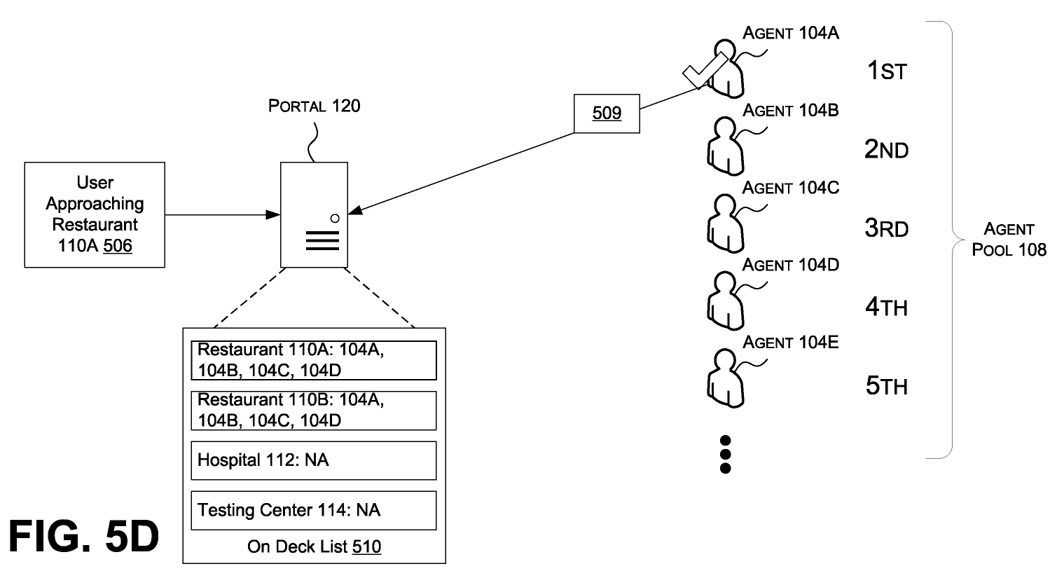

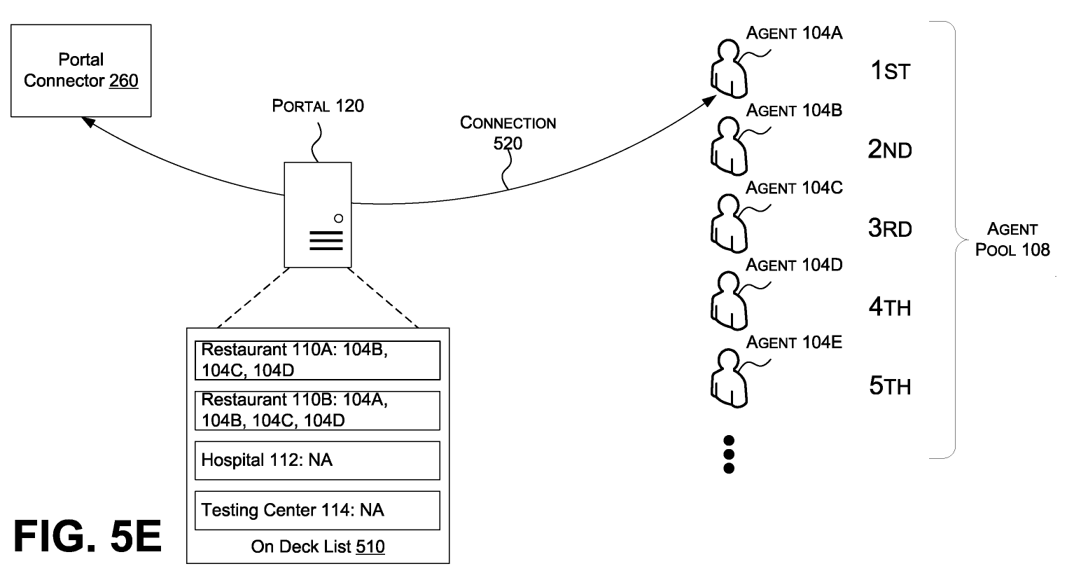

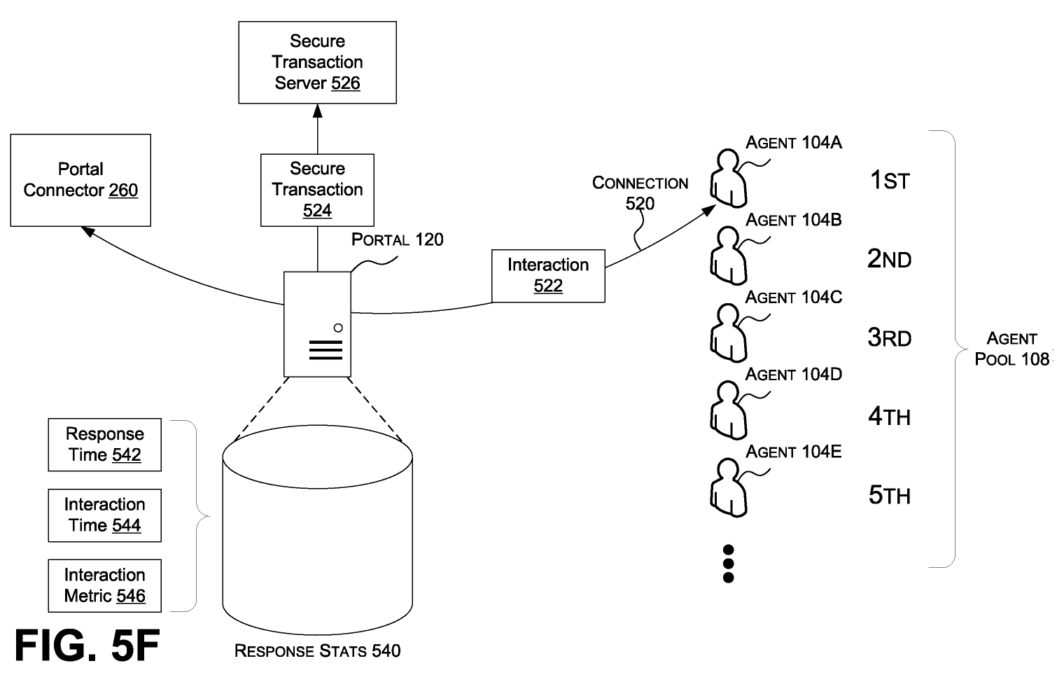

FIG. 5A illustrates soliciting agent availability for a particular organization. In order to connect an agent to a station in a timely manner, on-deck list 510 maintains a list of agents that are available to engage with a station 210 of a particular organization. This on-deck list 510 is also referred to herein as a pool of available agents. As illustrated, on-deck list 510 is empty, indicating that portal 120 has not yet found any agents that are available to work with any of the listed organizations. FIG. 5A Also illustrates the ordering of agents 104 in agent pool 108. Agent 104A is first in line, followed by agent 104B, etc. All else being equal, an agent that is closer to the front of the line will be put on-deck sooner than an agent that is closer to the end of the line.

The order of the agents can be based on a first-in-line or first-in first-out order. The order of the agents can be based on performance metrics as well. For example, if a first agent has a proven history of being more available than a second agent, the system may prioritize the first agent over the second agent. Similarly, if the first agent has timing metrics with respect to a particular set of orders that indicate a higher level of efficiency than timing metrics of other agents, that first agent may be prioritized over the other agents in the pool.

FIG. 5A illustrates portal 120 sending out availability inquiry message 502 to a number of agents. Availability inquiry message 502 asks if the agents 104 are available to be on-deck for a particular restaurant 110A. As indicated in FIGS. 5A, each restaurant entry of on-deck list 510 indicates that no agents are listed in these pools.

FIG. 5B illustrates receiving an availability confirmation. As illustrated, portal 120 receives confirmation messages 504 from agents 104A, 104B, 104C and 104D. This indicates that these agents agree to be the on-deck agent for the first two restaurants 110A and 110B. This means that these agents will be assigned to the pool of agents of the first restaurant 110A and the second restaurant 110B. When the agents are put on-deck for an organization with multiple locations, agents 104A, 104B, 104C and 104D may be assigned to assist end users (customers) from any of these locations, greatly expanding the number of end users the agents may assist. As a result of receiving confirmation messages 504, the first and second restaurant entry of on-deck list 510 has been updated to store a reference to agents 104A, 104B, 104C and 104D. In this example, none of the confirmation messages indicated anybody for the hospital or testing center.

FIG. 5C illustrates receiving an indication 506 that a user is approaching a queue within an organization. For example, with reference to FIG. 2, user 220B may have left queue 218B, leaving it empty. Then, another user 220A may have entered queue 218B. The approach of user 220A may be identified by sensor 230, a camera 219 on station 210, or any of the other techniques described herein.

FIG. 5C also illustrates messaging to the on-deck agents for the location that is associated with the indication 506. In this part of the process, the system can send a predetermined number of work requests 508 to agents that are available for that location. In this case, the on-deck list indicates a pool of agents that are available for that one particular location and a predetermined number of work requests are sent to those agents. In this example, the predetermined number of agents is three, thus Agents 104A, 104B, and 104C each receive a work request 508. The work requests are sent in response to the indication 506 that a user is approaching a queue within an organization. Agents 104A, 104B, and 104C are at the top of the agent pool for that one location, and as such are considered first. According to training 304A and availability, agent 104A is trained to work with users of a particular restaurant 110A. Therefore, these agents are given the first opportunity to sign up as the selected agent for restaurant 110A.

FIG. 5D shows how one of the agents is selected. After the work requests are sent to the predetermined number of agents, each agent has an opportunity to send a response 509. The first agent that responds to a work request is selected as the selected agent for the queue where the approaching end user is located. In this example, the first agent 104A responds first, and thus is selected as the agent for that queue.

FIG. 5E illustrates creating a connection between the selected agent and the portal connector on-site. Connection 520 may be a secure connection between the computing device used by the selected agent 104A to portal connector 260, which is on-site where the agent 104A will take the order. Once the first agent 104A is connected to portal connector 260, that person may be removed from the pool of available agents for that location. This removal of the first agent 104A is indicated in the list 510 of FIG. 5E. Portal 120 may begin soliciting another on-deck agents 104 for restaurant 110A, so that if another queue needs attention, other agents, such as Agents 104B, 104C or 104D, can be selected using the same process of sending a predetermined number of work requests and selecting the agent with the first response.

FIG. 5F illustrates a secure transaction 524 routed from the portal connector 260 through portal 120 to a secure transaction server 526. FIG. 5F also illustrates interaction 522 between agent 104A and a user 220. Interaction 522 is any conversation, spoken, written, or verbal, between agent 104A and user 220. Allowing interaction 522 to be transmitted to agent 104 while ensuring that secure transaction 524 goes directly to secure transaction server 526 allows agent 104A to use their own computing hardware without risking exposure of user 220’s personal financial data.

FIG. 5F also illustrates metrics that are captured over the course of interactions between agent 104A and user 220. For example, response time 542, interaction time 544, and interaction metric 546 are stored in response statistics database 540. Response time 542 refers to how long it took the agent to first speak with the user. Lower is better. Interaction time 544 refers to how long it took for the order to be completed. Lower is better. Interaction metric 546 is any measure by which agent 104 may be judged. For example, the dollar amount of an order or inclusion of specific promotions or add-ons may be noted. These statistics may be used to give preference to better performing agents, e.g., higher agents can be placed first in a pool or on-deck lists.

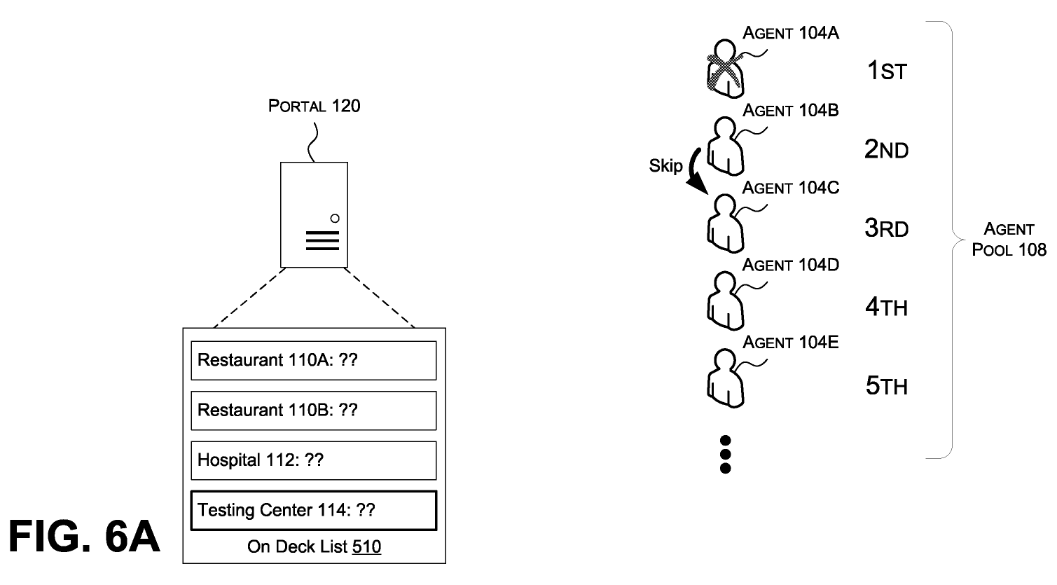

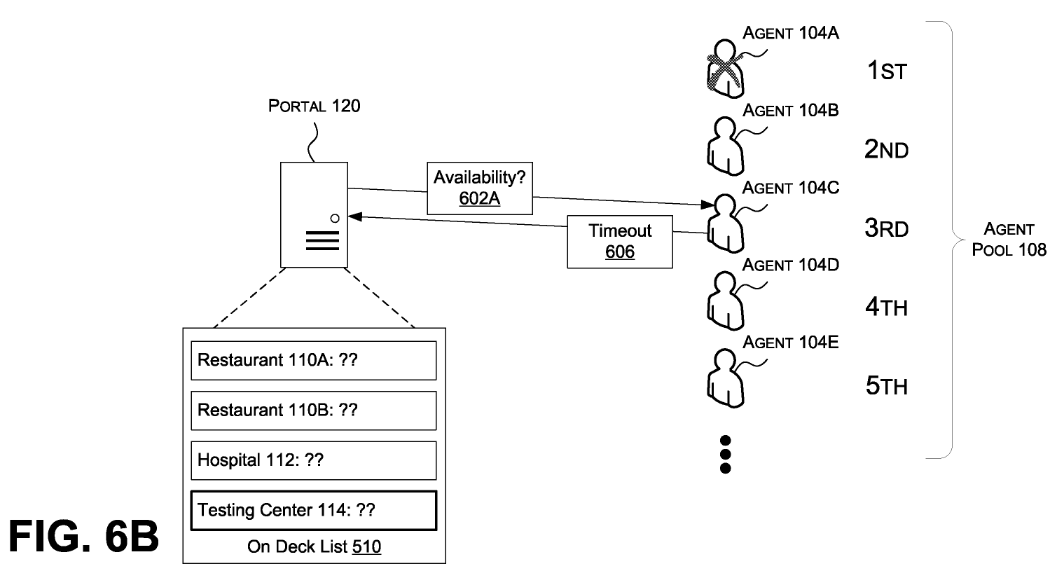

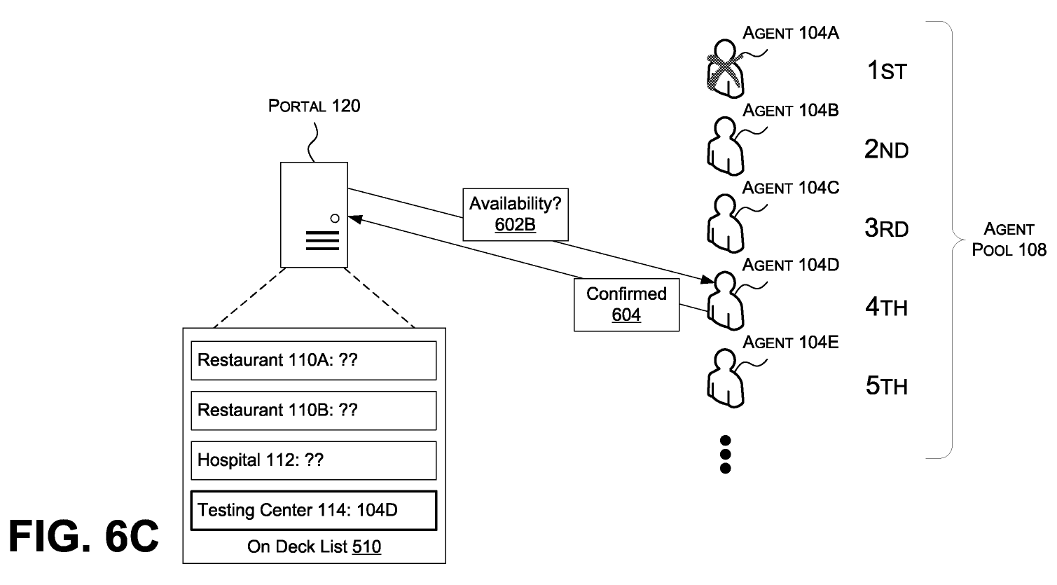

FIG. 6A illustrates skipping an untrained agent while soliciting availability for an organization. FIG. 6A illustrates determining the on-deck agent for testing center 114. Agent 104A has already begun interacting with users at a station in restaurant 110A, and as a result has been removed from the top of agent pool 108. FIG. 6A also illustrates skipping agent 104B, who is now at the top of agent pool 108 but who has not been trained to assist users at testing center 114.

FIG. 6B illustrates soliciting agent availability for an agent trained for the organization and receiving a time-out. After skipping agent 104B, availability inquiry message 602 is sent to agent 104C. However, agent 104C is unavailable at the moment. For example, agent 104C may be out to lunch. As a result, a timeout message 606 is sent by agent 104C’s computing device to portal 120, indicating they are not available. In some configurations, agent 104C retains their place in agent pool 108, although they may also be demoted or removed.

FIG. 6C illustrates soliciting agent availability for the next trained agent in the pool. Availability inquiry message 602B is sent to agent 104D, similar to the availability inquiry message 502 discussed above in conjunction with FIG. 5A. Agent 104D may agree to be the on-deck agent for testing center 114, causing confirmed message 604 to be sent to portal 120. Upon receiving confirmation message 604, portal 120 may set agent 104D as the on-deck agent of testing center 114.

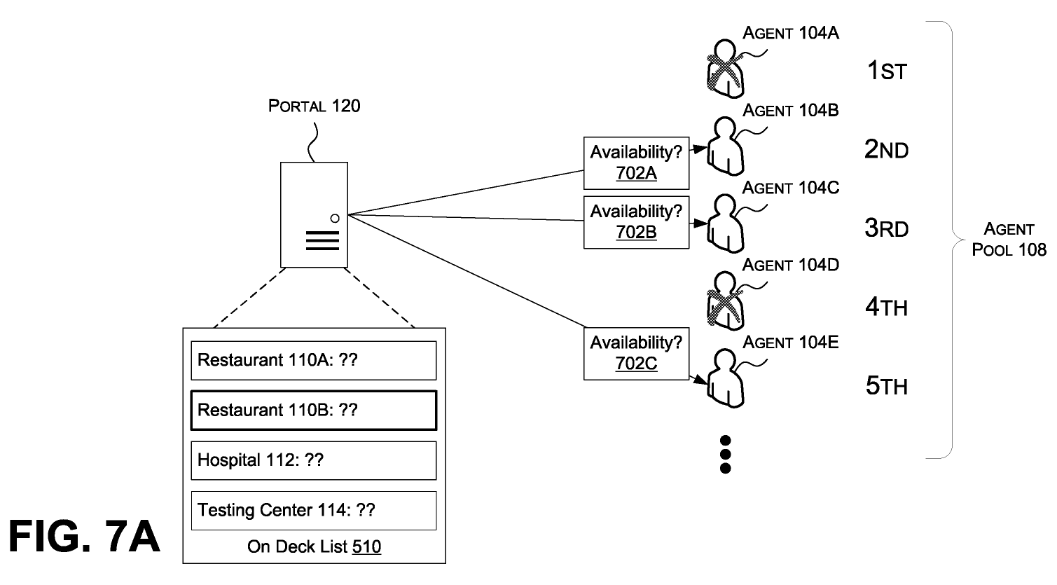

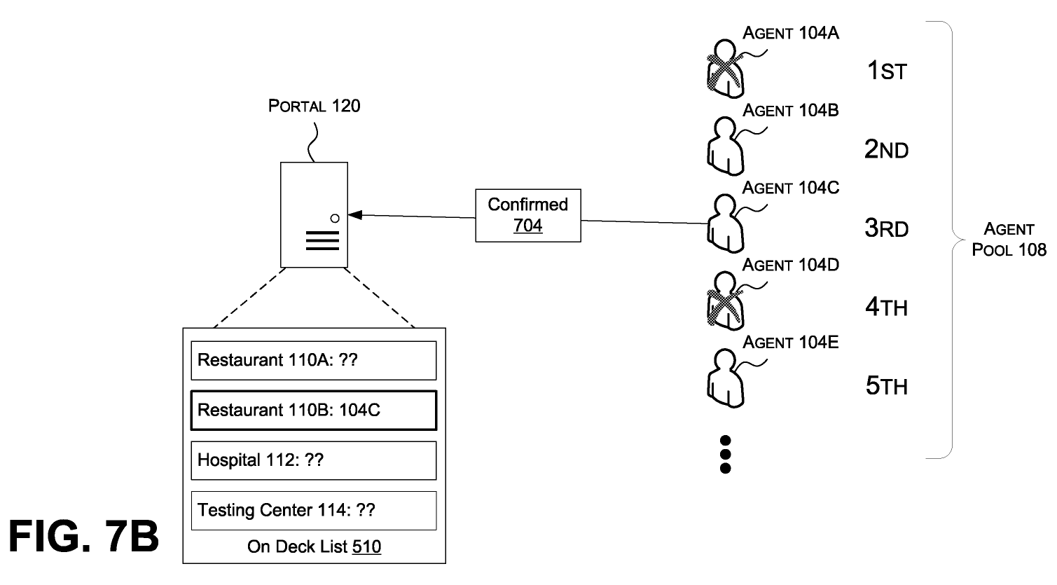

FIG. 7A illustrates soliciting agent availability from three agents at the top of the agent availability pool. Agents 104A and 104D have already been selected as on-deck agents, and as such are removed from the top of available agent pool 108. In order to improve responsiveness, portal 120 may send out multiple availability inquiry message 702 to multiple qualified agents 104 at the top of available agent pool 108. While FIG. 7A illustrates 3 such messages, any other number of messages is similarly contemplated. FIG. 7A illustrates attempting to set the on-deck agent for restaurant 110B, which agents 104B, 104C, and 104E are certified to work with.

FIG. 7B illustrates setting the on-deck agent to the agent that returned the first confirmation. Agent 104C responds first with confirmation message 704. This establishes agent 104C as the on-deck agent for restaurant 110B. On-deck agent 104C will be connected to a station at one of the locations of restaurant 110B at the appropriate time, similar to the discussion above in conjunction with FIG. 5E.

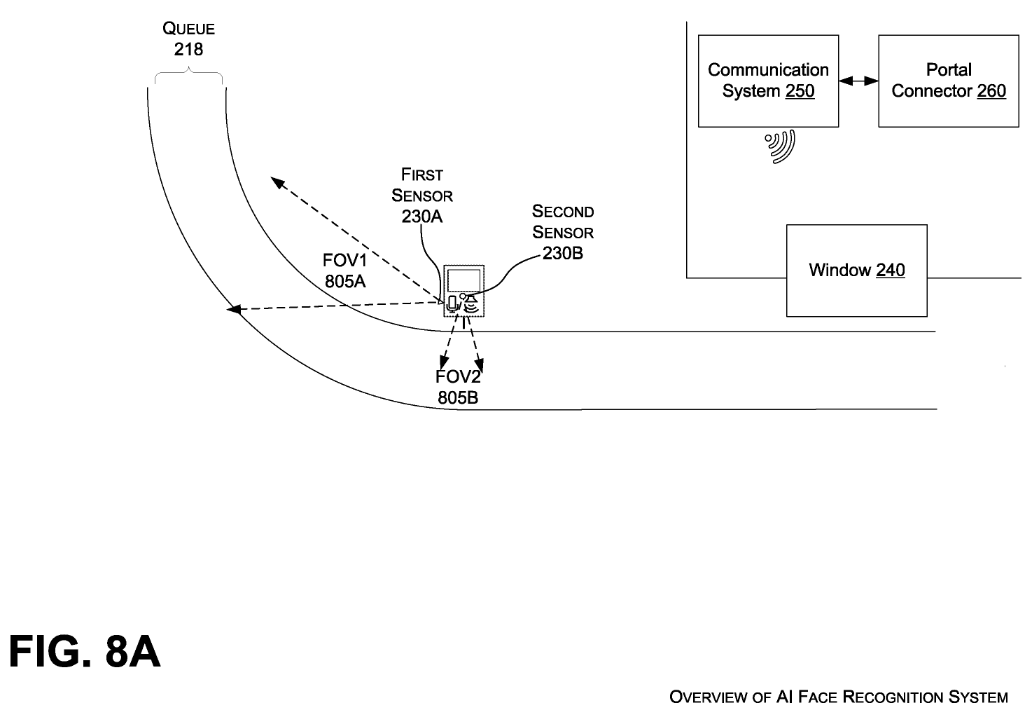

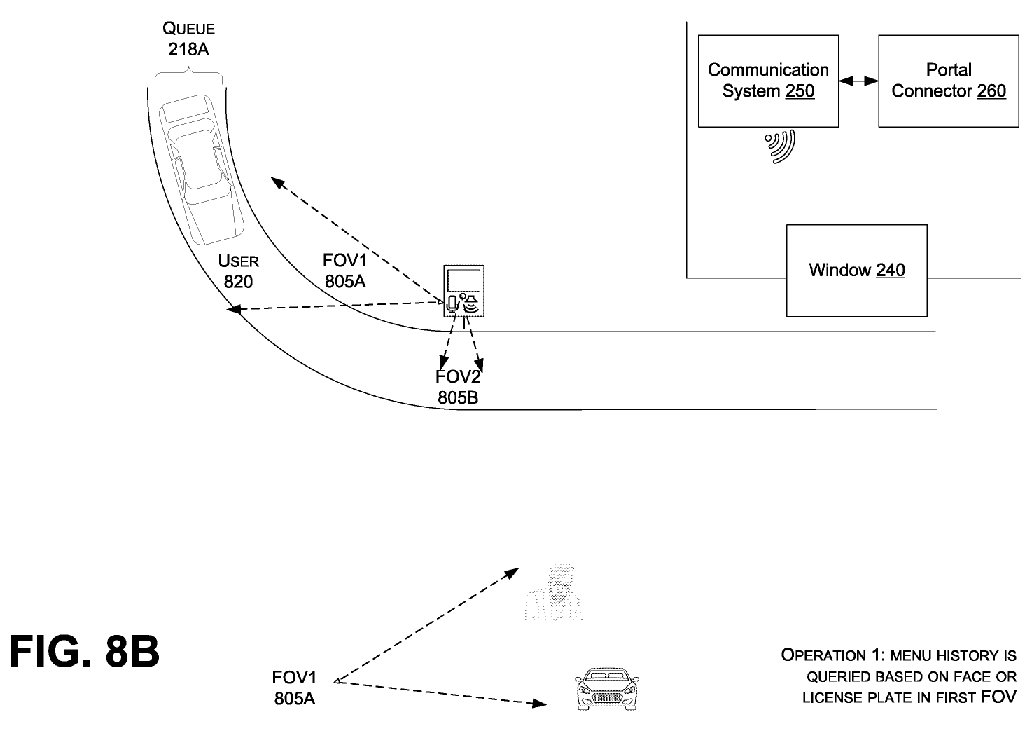

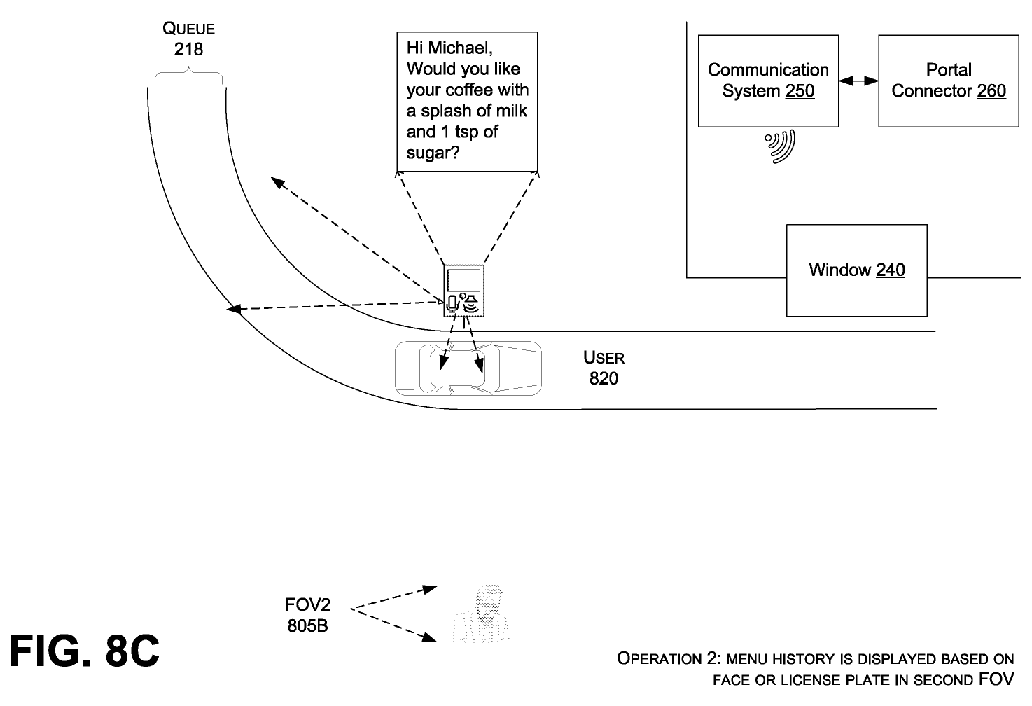

Turning now to FIG. 8A, a system for utilizing license plate information and/or facial recognition for generating order recommendations is shown and described below. In this example, a station can include two sensors 230 that each include a field of view 805 (FOV). The first sensor 230A can be positioned and oriented such that the first FOV 805A is directed toward a queue 218. The second sensor 230B can be positioned and oriented such that the second FOV 805B is directed away from an ordering station and directed toward the front of the queue. As shown in FIG. 8B, when the user 820 reaches a predetermined location in the queue, e.g., where the first FOV 805A (FOV1) is in a position where a camera can capture the user’s face and/or license plate, the system can determine an identity of the user. Using the identity, the system can retrieve the user’s order history and other preferences. As shown in FIG. 8C, the user’s order history and preferences are then displayed on a screen in front of an agent when the user moves into the second FOV 805B (FOV2). Thus, the two sensors are used to (1) retrieve the user’s order history and preferences, then (2) display the user’s order history and preferences to an agent only when the user is in front of the station.

In some embodiments, the display of the order history and preferences may only be displayed to an agent’s computer when the user, e.g., the customer, is in front of the station and the user is identified by the system, e.g., by use of the system’s facial recognition or license plate recognition. In addition, the order history and preferences may only be displayed to the display screen of the station when the user is in front of the station and identified by the system. The order history and preferences are not displayed if the user is not identified and in front of the station in the second FOV. This way, stations with multiple queues will increase their accuracy in aliening orders with customers and the customer’s privacy is improved by only displaying a user’s order history and preferences to identified users. User privacy could be an issue when there is a system with two or more rows of cars and they interweave into a single row prior to reaching a station. This multi-sensor setup increases the speed and accuracy of each person’s order as well as improving privacy and security features of a system.

In any of the disclosed embodiments, the system can apply different priorities to each queue for agent assignments based on a type of queue. There are several different types of queues, which can include, but is not limited to: a drive-thru queue, a counter queue, and a teleconferencing queue. The drive-thru queue can include any type of setup that serve customers in their motor vehicles. The counter queue can include any type of setup that serves customers in a building, The teleconferencing queue can include virtual meetings or phone calls from customers arranging a delivery or a pickup. In one embodiment, all types of queues have the same priority when agents are assigned. The agents are assigned to each queue on a first come, first served basis regardless of the type of queue that customers are detected. In other embodiments, the algorithm assigns a different priority to each type of queue. For instance, the system may prioritize a drive-thru queue over a teleconferencing queue, and prioritize the teleconferencing queue over a counter queue. In such an example, when a customer approaches a drive-thru, the assumption is that the user is in a hurry. Whereas a customer at a counter or a customer on a phone may not be in as much of a hurry compared to customers in a car. Thus, in such embodiments, if there are multiple customers waiting in each queue, the system would assign an available agent to drive-thru queue before the other types of queue.

To facilitate some of the above-described embodiments, a hardware sensor is used at the counter queues and/or the drive-thru queues. In such embodiments, the MQTT protocol may be used to notify agents that a user is present at a restaurant drive-thru or front counter. Eligible agents are informed in response to the detection of an end user and an audio system starts an audio connection between the current customer and the agent.

Agents may be selected and allocated to a particular queue in response to the detection of an end user entering a queue. When an end user approaches the queue, a sensor detecting the presence of the end user can cause the system to send work requests to a predetermined number of available agents. For instance, a number of available agents can be prioritized in an agent pool. Those agents can be prioritized using one or more factors including, but not limited to, performance metrics, first-in-line ordering, etc. In one illustrative example, if an available agent pool has five hundred available agents, the system may send work requests to the first three available agents based on their priority. The system can be configured to receive confirmations from each agent that receives a work request. The first available agent that provides a confirmation is selected as the primary agent that is to communicate with end users located at the queue.

Once an agent has been assigned to a queue, the agent is removed from the agent pool in response to the detection of a predetermined event. The agent may be connected to the system to communicate with an end user in the queue and provide services for the end users in the queue until the queue empties. When the system determines that a queue is empty, e.g., there are no more cars in the drive-through line, the agent is removed from the queue and the system disconnects the agent's communication with a communication station associated with the queue. When an agent is removed from a queue, that particular agent may be returned to the agent pool. When an agent is returned to the agent pool, in some embodiments, those agents are prioritized according to their performance metrics, or they may be positioned at the end of a line when a first-in-line model is utilized. An agent may also request to leave the queue. In such scenarios, the system can utilize the above-described process to select a new agent from the available agent pool before the agent is released from the queue.

In some embodiments, a system can control a position for each end user, e.g., each customer, within a queue. For example, for a teleconferencing queue, an end user may opt out of the queue for a predetermined amount of time, if they need more time to decide what to order. The system can receive an input from the end user, e.g., a voice command or a manual input to an input device, indicating an inactive status for the queue. The input can include a time for the inactive status. In some embodiments, the inactive status can be invoked in response to the system detecting a pause in communication. A detected pause for a predetermined time period causes a user to move into an inactive status for a time period, an “indicated time.” In one specific example, an active period can be a predetermined time period, e.g., 5 minutes. The system can re-insert that end user into the queue after the indicated time has passed.

While the end user is in an inactive status, the system can send a prompt to the end user, prompting the end user to provide an updated status. In response, the system can receive an update indicating the end user wants to continue in the queue, or system can receive an update indicating the end user wants to drop from the queue. The user can choose to remain in the queue or opt out entirely. The prompt can be sent in response to one or more events. The event can include detection of the end user being in a next-in-line position, e.g., second place in line.

The system can also provide agent training tools and agent management tools. These tools include customized online courses and systems for monitoring the progress of each agent taking the online courses. The system monitors the progress of each agent, and automatically grants permissions for each agent to join an agent pool or one or more queues of a particular organization or certain queues within an organization based on the completion of predetermined training milestones. The system provides online courses that allow the agents to become trained for specific locations, e.g., specific restaurants. This allows organizations to require specific courses for a particular location, a specific queue, or a specific set of queues. The online courses provide simulated customer-agent interactions that allow the agents to practice orders using actual menus used at particular locations.

The system also automatically measures several performance metrics for the online courses, including speed and accuracy metrics for simulated orders. The system also automatically upgrades a user’s skill level to more complex orders as the agent learns the software. When an agent meets a threshold performance metric for a course required for a location or a queue, that agent is allowed to join a pool for that location or a specific queue for a particular location. Then, that agent is eligible to be selected to interact with end users, e.g., customers, by the use of the other queuing techniques disclosed herein. By the use of these tools, before any agent’s first shift, they have already learned the menu, practiced taking orders, and developed the trained reactions for a particular location. This system allows for scalability as well, since a large number of agent candidates can be trained and managed using automated training methods.

The training tools also provide administrative features that allow admin users, e.g., location managers, to oversee agent pools. The system provides a user interface (UI) that shows lists agents who have completed predefined training tasks and who have been added to agent pools for a particular location. This UI allows a manager to see which agent is available for a pool, and tools for allowing the manager to assign agents to pools, or allows the manager to confirm agents who are recommended to specific pools. In one illustrative example, consider a scenario where there are 20 restaurant locations for a single pool. The management user interface can show agent pools and individual lobbies that are each associated with individual restaurants within an organization. Each lobby can show specific agents that are associated with a specific admin user, e.g., a manager, and each lobby can be associated with a specific location. In such an example, there might be 20 different lobbies, one lobby per franchise rather than one lobby for an entire company.

The system can generate a UI showing information about each agent and their association with any assigned queues. The UI can also show representations of individual locations, e.g., restaurants, and stations within each location for each manager. A station is a point of contact for a particular queue. For instance, on a drive-thru, a station is the point at which a customer’s vehicle reaches a camera and microphone. This system allows the managers to oversee a large number of organizations, locations, and individual stations at each location.

The system grants each manager permission to access each agent profile. This allows each manager to oversee a station if any issues arise. For example, the system can provide a manager with an input control that removes an agent’s from a particular station if the agent is having connectivity issues or if they are encountering other customer interaction issues. Managers can remove agents from a queue or add agents into a queue. The system can provide a notification to a manager if a minimum threshold of agents is reached, e.g., there are not enough assigned agents in a queue. A minimum threshold is the number of agents needed in a queue to ensure that the system is operating as efficiently as possible. The agents can be manually added to a queue, or the system can automatically allocate agents as needed to fulfill a minimum threshold of agents. The system can also allow managers to approve or decline any new agent that is automatically added to a queue.

By dynamically connecting agents to a queue and disconnecting agents in response to particular events, a system can provide a seamless, consistent customer service experience while allowing an organization to maintain a reduced number of active agents versus a number of agents that is normally required by traditional drive-through systems. For example, by the use of the techniques disclosed herein, a restaurant chain can staff 20,000 individual franchise locations using 5,000 to 15,000 agents who are dynamically allocated and re-allocated to queues at each location. This can greatly improve efficiency and utilization of a number of resources, including human resources and computing resources, versus traditional systems. Traditional systems require at least one agent fully dedicated to each franchise location, and traditional systems can involve processes where each agent and their associated systems have hours of idle time per day. Additionally, the same pool of agents is used for all the different types of agent queues, further improving the efficiency of these organizations.

In some configurations, a pool can be assigned to a select set of queues. This can include all queue types, e.g., counter queues, drive-thru queues, and teleconferencing queues. In addition, the pool can be assigned queues at different site locations. This allows agents assignments to jump from city to city within the same organization or even within different companies. This allows a group of agents to serve in queues and locations where they are needed most and times where they are needed. For example, an agent may take an order at a pizza shop in Oakland, CA from a front counter, then be immediately reassigned to take an order at an Italian restaurant in Arlington, VA from a drive-thru. These features allow managers to assign agents to queues and locations and companies based on their trained skillset. In addition, the disclosed features also allow managers to utilize a smaller number of agents to service locations in different time zones. This allows one set of agents to work with several workload waves, e.g., multiple lunch rushes. In another example, a single company, for example, a mom-and-pop restaurant with one location, can be put in the same queue as other similar shops. The agents provide an opportunity for these organizations to greatly reduce the number of people needed to staff a smaller company. For example, instead of needing ten people for ten locations, a manager could have three people running those ten locations, even though the locations are associated with different companies.

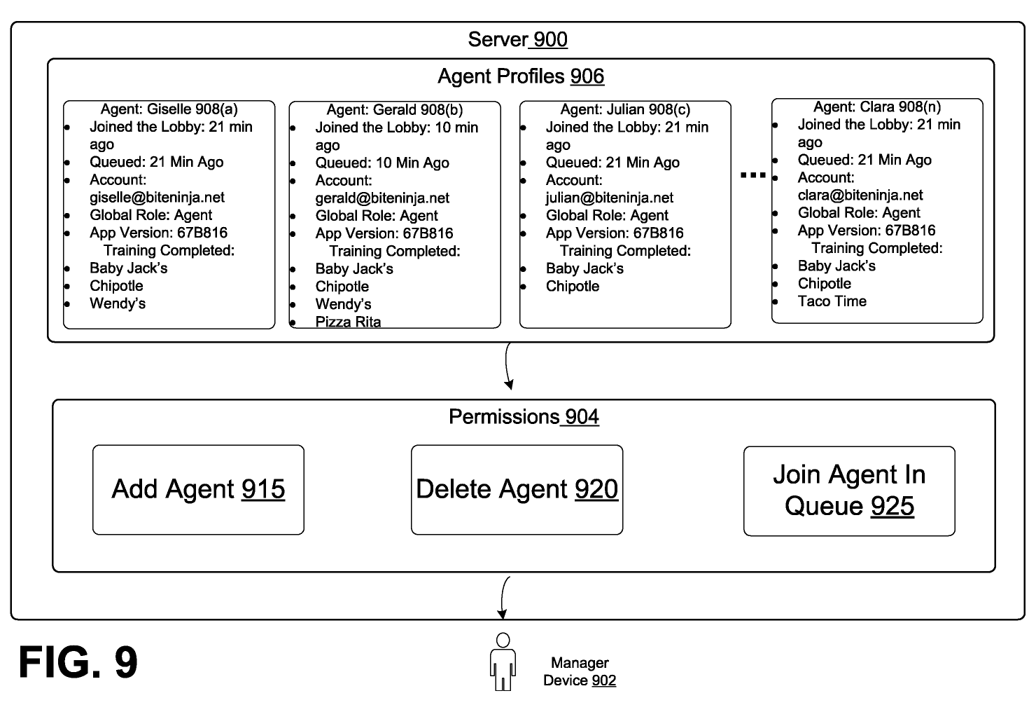

FIG. 9 illustrates aspects of a training and management tool for users who are overseeing a number of agents and a number of locations. In this example, the system displays a “lobby” to an admin user, e.g., a manager of agents. The lobby can include profiles and permissions for each agent that is associated with a particular manager. The agent profile 906 provides information such as the name of the agent, when the agent joined the lobby, when the agent was last queued, the agent’s account information, the agent’s role, and the training that the agent has completed. The system sets permissions for a manager device 902 that can display the profiles. The manager device 902 has access to this information throughout the course of the agent’s shift. Additionally, the manager device 902 handles permissions 904 that help manage the agents throughout their shifts. In one configuration, these permissions include adding an agent 915, deleting an agent 920, or joining the agent in the queue 925. An agent may need to be added to the lobby if the number of agents does not meet the minimum threshold required for the queues to run in an efficient manner. An agent may be deleted from the lobby if there are more than a threshold of agents for a queue, and/or if there are too many agents in an idle state, e.g., not actively connected to a station. Thus, the system can remove agents from a lobby if or a pool if a number of agents have more than a threshold amount of idle time. In another example, the system can allow the manager to monitor customer-agent communication. If the manager notices that an agent is having technical difficulties or struggling with an order, and they may need to join the agent in the queue to assist with the order.

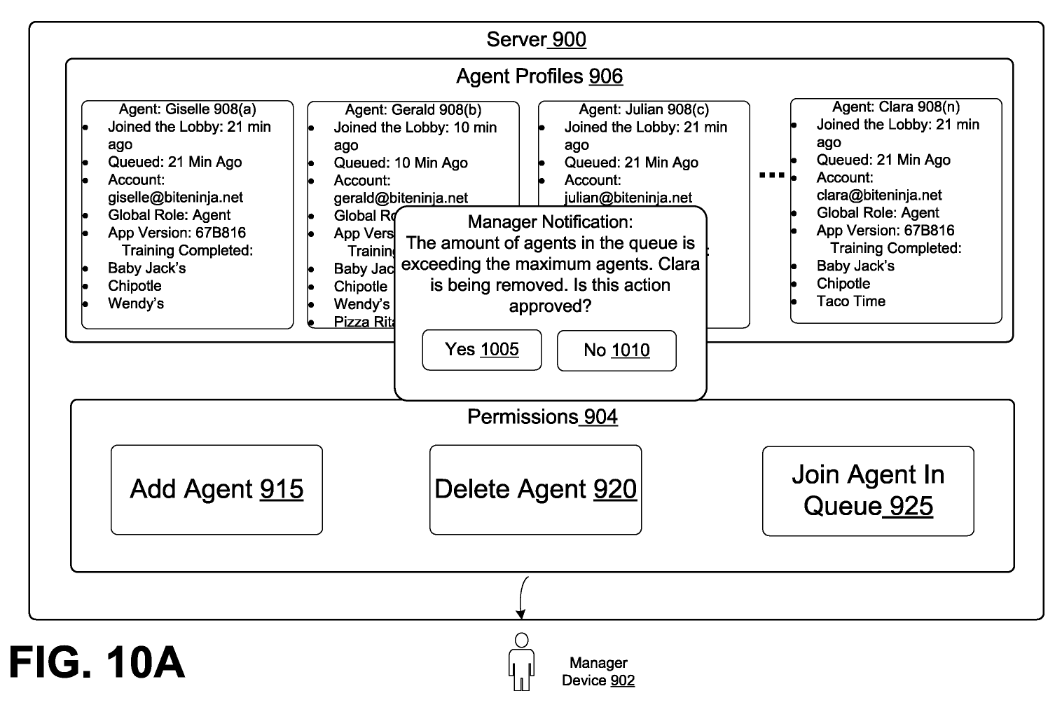

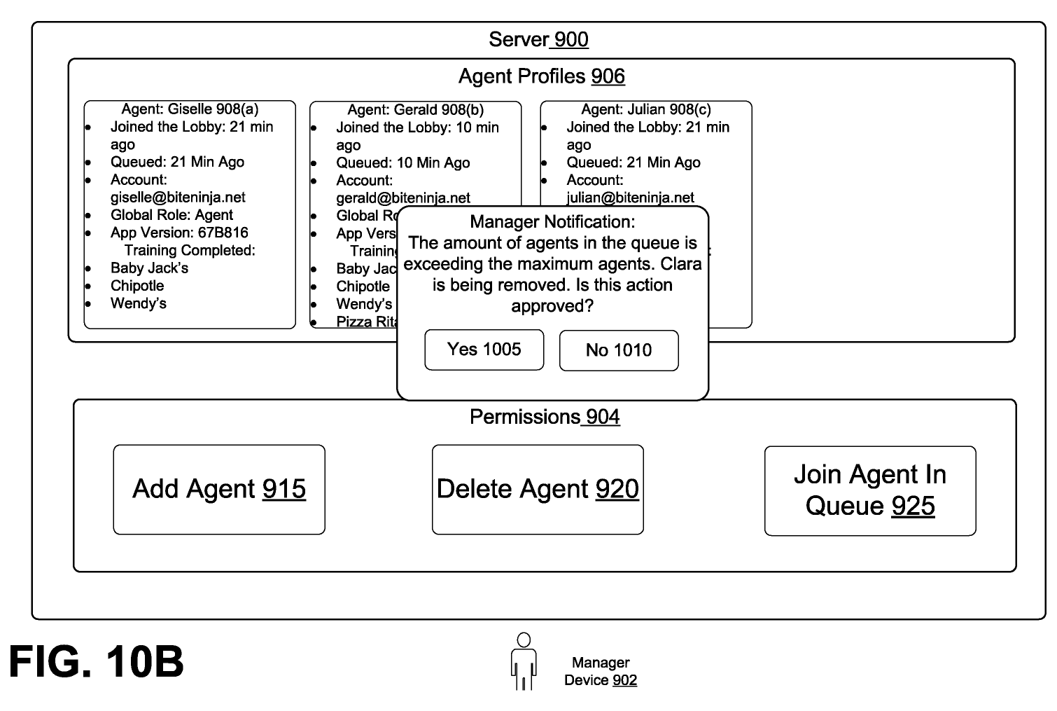

FIG. 10A illustrates a notification 1000 that can be displayed on a manager device 902 when the number of agents exceeds the maximum needed for the queue. In this example, the system detects a scenario where there are too many agents in a lobby.. This notification indicates that a particular agent, e.g., Clara, is being removed from the lobby. The manager device 902 has the option of confirming this recommendation or declining the recommendation. The system can also automatically remove the agent without providing a recommendation and requiring a response..

FIG. 10B illustrates an example of the user interface where a user of the manager device provides an input approving the recommendation of removing an agent. In response to the input, the manager device removes the agent from the lobby. The system is now configured to select agents for one or more queues only using remaining agents who are listed as members of the updated lobby. The removed agent may be added to a different lobby to accommodate a location or other manager with a higher demand.

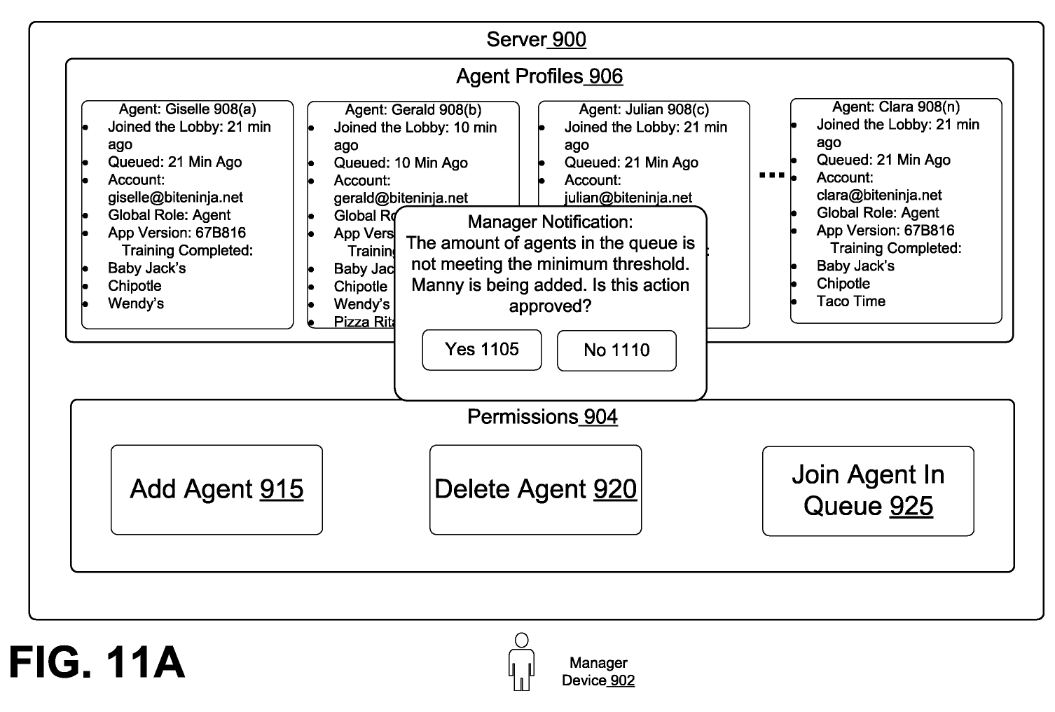

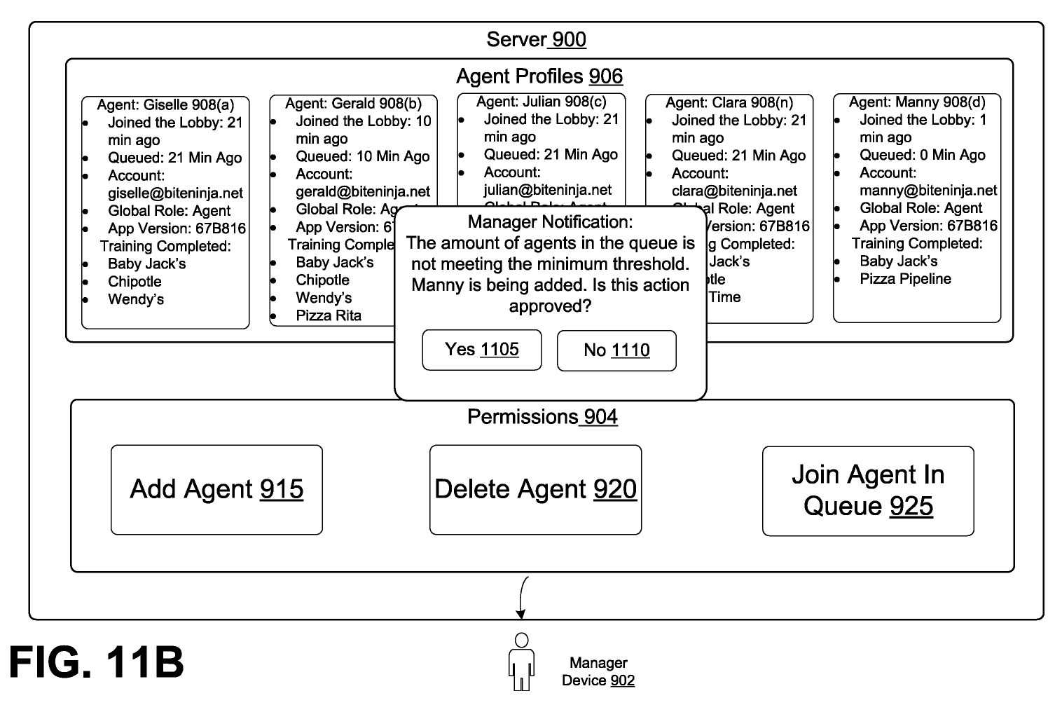

FIGS. 11A-11B show another example scenario of the management tool where agents are added to a queue. FIG. 11A illustrates a notification 1100 that is displayed on a manager device 902 when the system determines that the number of agents in a queue is not at a minimum threshold. In this example, the system determines that the number of agents in the queue does not meet a minimum threshold in response to the detection of one or more predetermined events. The predetermined events can include a scenario where the system detects that one or more customers has to wait more than a threshold amount of time for an agent to connect to a station. The system can automatically add an agent to a queue, or the system can make a recommendation to add an agent and wait for a manager to confirm the recommendation. In the example of FIG. 11A, the manager device 902 displays a notification 1100 that an agent, e.g., Manny, is being recommended for a queue. The manager device has the option of confirming this recommendation or declining the recommendation.

FIG. 11B illustrates an example of the user interface where a user of the manager device provides an input approving the recommendation of adding an agent to the queue. Once the manager device 902 approves the recommendation, the system adds an agent to the lobby. As shown, the system now displays the profile of the added agent, e.g., Manny. The system is now able to select agent candidates, including Manny, for a queue based on this updated lobby. The system determines if the minimum threshold of agent has been reached. If the system does not meet the minimum threshold of agents, the system adds additional agents.

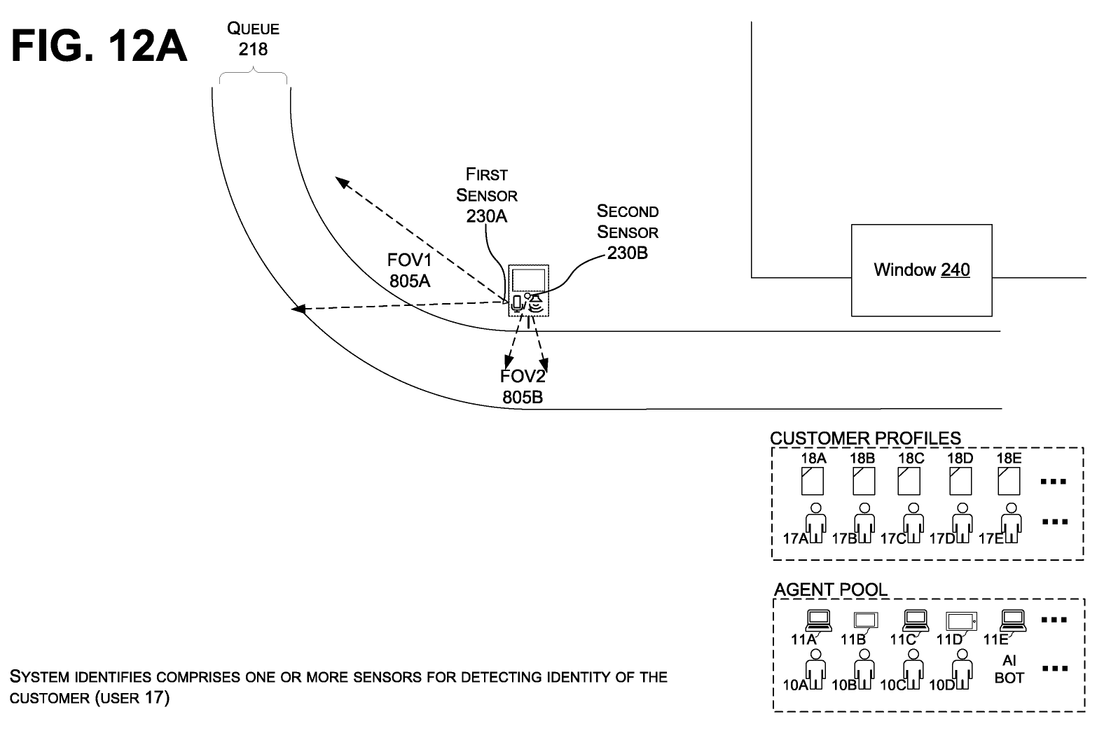

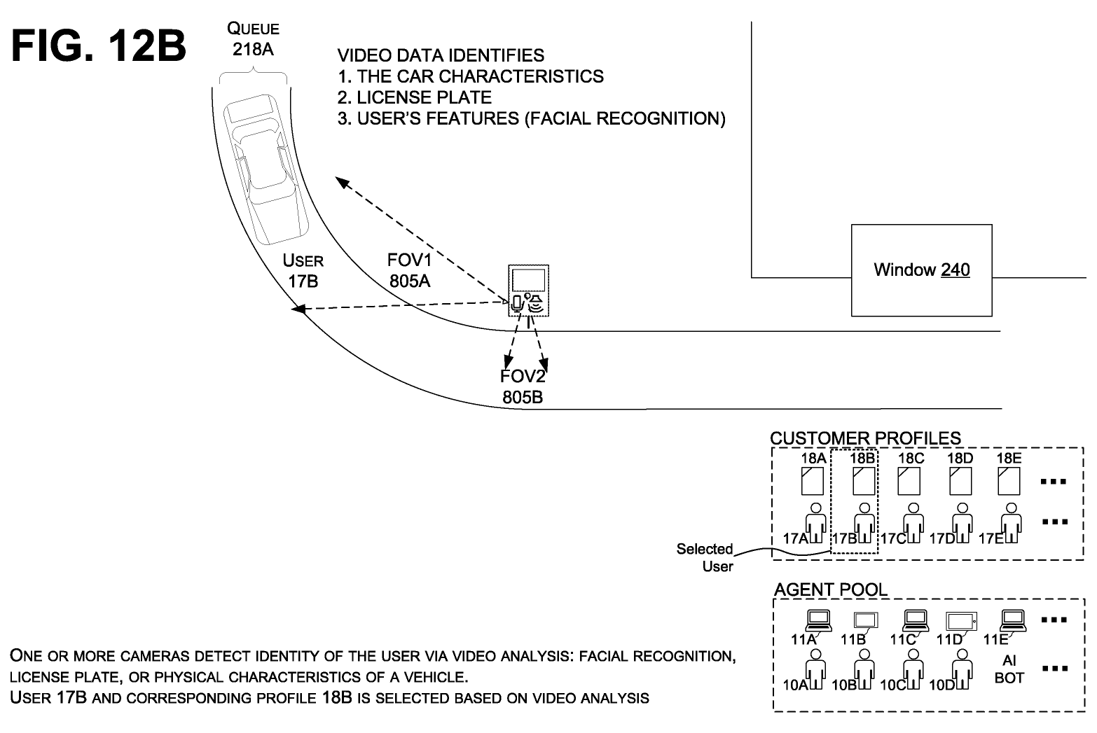

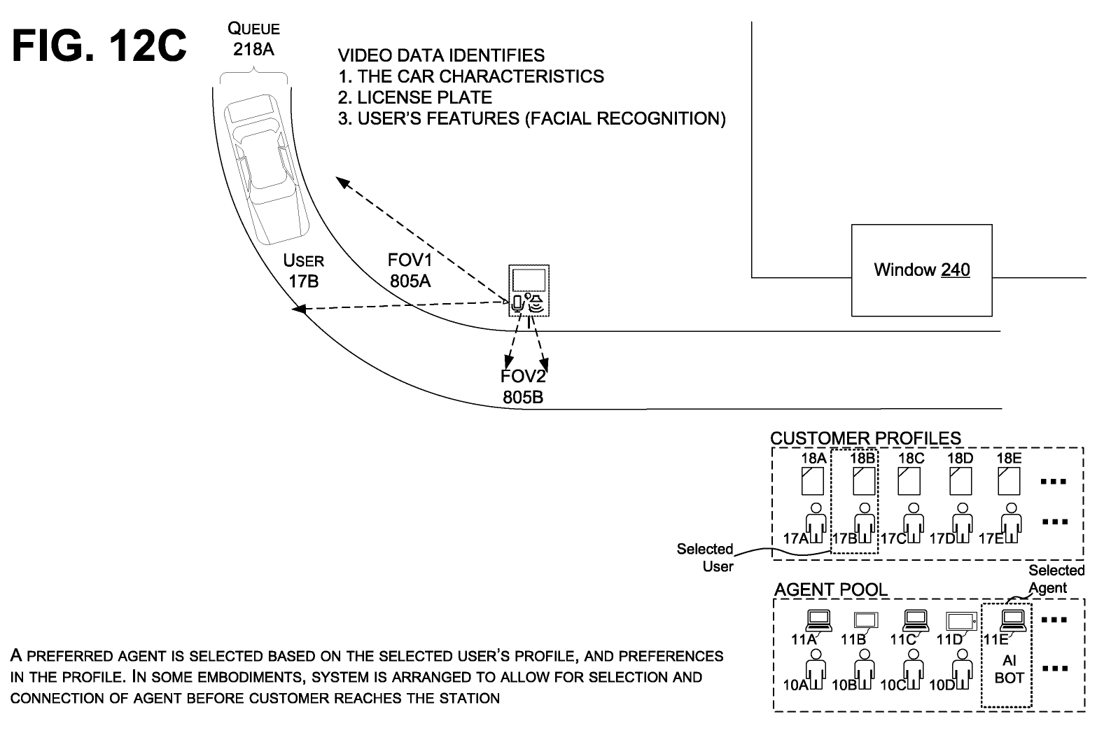

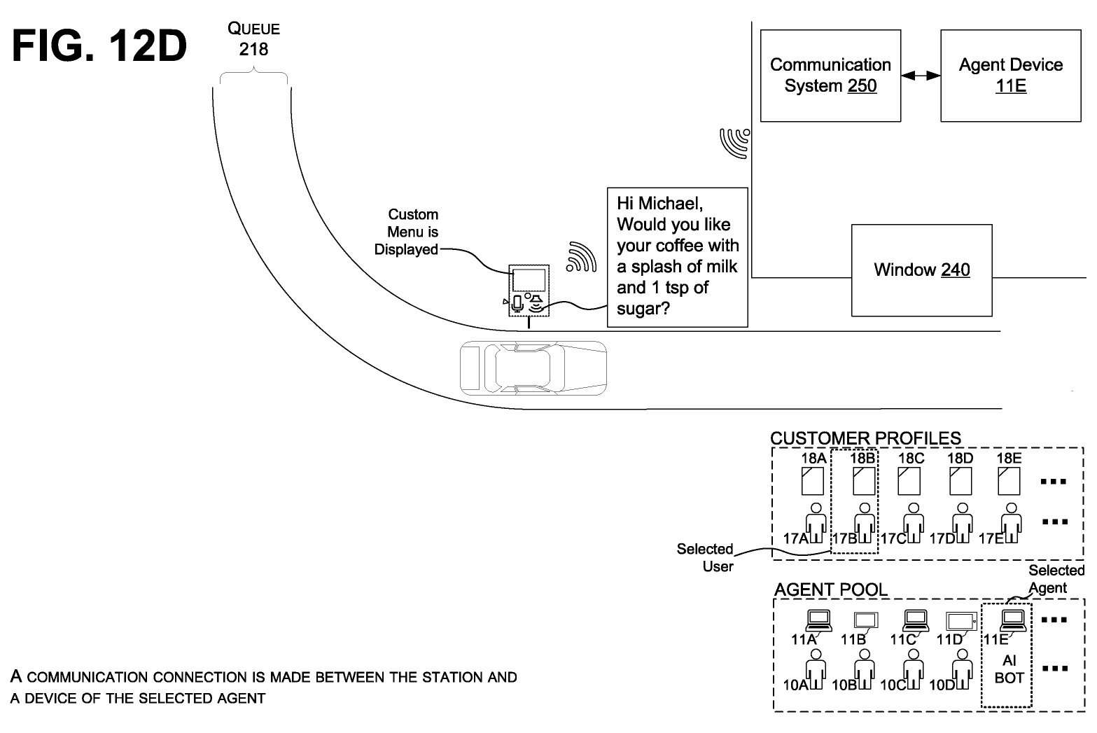

Turning now to FIGS. 12A through 12D, an embodiment used in a scenario involving allocation of interaction resources from a shared pool of agent devices to service multiple interaction stations is shown and described below. The embodiment illustrates how a distributed interaction system detects the presence of an end user at an interaction station, identifies available interaction agents from a shared pool of agent devices, and establishes a communication connection between the interaction station and a selected agent device. In certain implementations, the system dynamically selects between connecting the interaction station to a human-operated agent device or to an automated agent process executed by a computing system. The figures further illustrate how automated processing components may assist with the interaction session while maintaining the ability of the system to dynamically allocate human-operated agents or automated agent processes through the communication system 250.

FIG. 12A illustrates an embodiment in which a distributed interaction system detects the presence of an end user at or approaching an interaction station positioned near a window 240 of a service location. In response to detecting the end user, the system may determine that assistance from an interaction agent may be required and may access a database of agent profiles to identify a subset of available agent devices capable of servicing the detected interaction request. The system may evaluate attributes associated with the available agents, such as training characteristics, organizational permissions, language capabilities, or other profile attributes. Once a subset of qualified agents is identified, availability requests may be transmitted through the communication system 250 to a plurality of agent devices associated with the qualified agents.

FIG. 12B illustrates an embodiment in which one of the contacted agent devices responds to the availability request and is designated as an available agent for a forthcoming interaction session. In certain implementations, the first responding agent device may be designated as an on-deck agent that is prepared to service the next end user reaching an interaction station. Because the agent device communicates with the system through the communication system 250, the agent may be remotely located and capable of servicing interaction stations associated with multiple service locations. This configuration allows the distributed interaction system to dynamically allocate agent resources across multiple interaction stations positioned near one or more windows 240 or service areas.

FIG. 12C illustrates an embodiment in which the system detects that the end user has reached the interaction station and establishes a communication connection between the station and the agent device associated with the selected agent. The interaction station may include a microphone, speaker, display device, and other interface components that allow the end user to communicate with the remotely located agent. When the communication connection is established through the communication system 250, the selected agent device may present contextual information associated with the end user on a display associated with the agent device while similar information is displayed at the interaction station. In certain embodiments, the system may determine that the interaction session should be conducted by a human-operated agent, and the system therefore connects the interaction station to a computing device associated with the selected human agent through the communication system.

FIG. 12D illustrates an embodiment in which automated processing components assist with the interaction session or are used as an alternative interaction modality. In some implementations, one or more automated agent processes may be executed on computing systems connected to the communication system 250. These automated agents may process audio input received from the interaction station, perform speech-to-text conversion, analyze the resulting input using artificial intelligence models, and generate recommendations or responses transmitted back to the interaction station. The system may determine whether to utilize the automated agent process or to establish a communication connection with a human-operated agent device based on factors such as historical interaction records, detected user preferences, geographic interaction patterns, or confidence levels associated with automated processing. In some embodiments, the system may initially utilize an automated agent process and subsequently establish a communication connection with a human-operated agent device when predetermined conditions are detected.

In this manner, the system illustrated in FIGS. 12A–12D enables dynamic allocation of interaction resources across multiple interaction stations and allows the system to select between human-operated agent devices and automated agent processes while maintaining communication through the communication system 250. This architecture allows interaction stations positioned near service locations such as window 240 to be supported by distributed human agents or automated computing systems located at any network-accessible location.

In certain embodiments, the distributed interaction system further improves operational efficiency by selecting interaction agents based on profiles 18 associated with end users and agents. The profiles 18 may store information derived from historical interaction records, prior interaction outcomes, user preferences, language characteristics, interaction duration metrics, or other attributes associated with previous interaction sessions. These profiles may be stored within a database accessible to the resource allocation engine and may be dynamically updated as new interaction sessions are completed.

When an end user is detected at an interaction station positioned near window 240, the system may retrieve a profile 18 associated with the detected end user. The system may then evaluate the retrieved profile in combination with profiles associated with available agents in the pool of agent devices. Based on this evaluation, the system may select a particular agent device, such as agent 11E, when the attributes of that agent correspond closely with attributes associated with the end user profile. For example, the system may determine that agent 11E previously conducted efficient interaction sessions with users having similar profile attributes and may therefore select that agent to service the detected interaction request.

In other implementations, the system may determine that an automated agent process, such as agent 11A, is better suited to service the detected interaction request. Agent 11A may represent a software-based interaction agent executed by one or more computing systems connected through the communication system 250. The system may select agent 11A when the profile 18 associated with the detected end user indicates that previous interaction sessions were successfully completed using automated interaction processes or when other characteristics associated with the profile suggest that automated processing is likely to produce efficient interaction outcomes.

The use of profiles 18 to dynamically select between human-operated agent devices, such as agent 11E, and automated agent processes, such as agent 11A, improves the efficiency of the distributed interaction system in several ways. By selecting interaction agents whose attributes correspond to characteristics associated with the detected end user, the system reduces interaction duration, minimizes repeated clarification requests, and decreases the number of manual inputs required during the interaction session. In addition, the ability to route interaction sessions to automated agents when appropriate allows the system to preserve human-operated agent resources for interaction sessions that benefit from human assistance.

From a system architecture perspective, this profile-driven agent selection mechanism improves the operation of the distributed computing system by enabling computing resources and human-operated agent devices to be allocated dynamically based on processed data associated with end users and agent profiles. Rather than relying on static assignment of agents to particular stations or locations, the system analyzes stored profile data and real-time interaction information to determine which agent device should service a particular interaction session. This data-driven allocation of interaction resources allows the computing system to coordinate multiple interaction stations through the communication system 250, thereby improving resource utilization and reducing latency associated with establishing interaction sessions.

These techniques represent technological improvements to the operation of distributed interaction systems. By integrating profile-based data analysis, distributed communication infrastructure, and dynamic allocation of human-operated and automated agents, the system improves the functioning of computer-based interaction platforms and provides a practical technological solution for coordinating interaction resources across multiple locations and devices.

In some embodiments, the profiles 18 may further include geographic information associated with prior interaction sessions of end users. For example, a profile 18 may include location attributes such as postal codes, regional identifiers, or other geographic indicators derived from previous interaction locations. The system may analyze historical interaction data associated with multiple profiles 18 within a particular geographic region to determine behavioral patterns associated with end users in that region. In certain implementations, this analysis may indicate that users associated with a particular geographic cluster more frequently interact with human-operated agents, such as agent 11E, rather than automated agents such as agent 11A. When a newly detected end user is determined to be associated with that geographic cluster, the resource allocation engine may prioritize selection of a human-operated agent device from the available agent pool and establish a communication connection through the communication system 250 between the interaction station positioned near window 240 and the selected human agent device. Conversely, when the geographic cluster data associated with the profiles 18 indicates that users in the region frequently interact successfully with automated agents, the system may initially select the automated agent process associated with agent 11A while maintaining the ability to transition the interaction session to a human-operated agent device when conditions warrant.

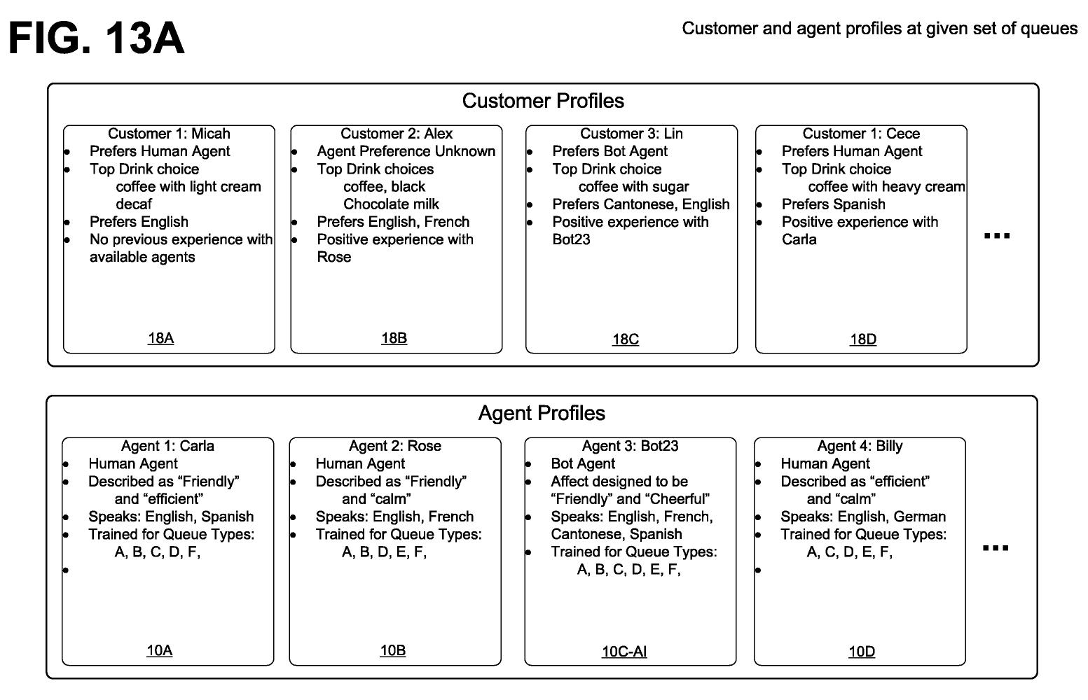

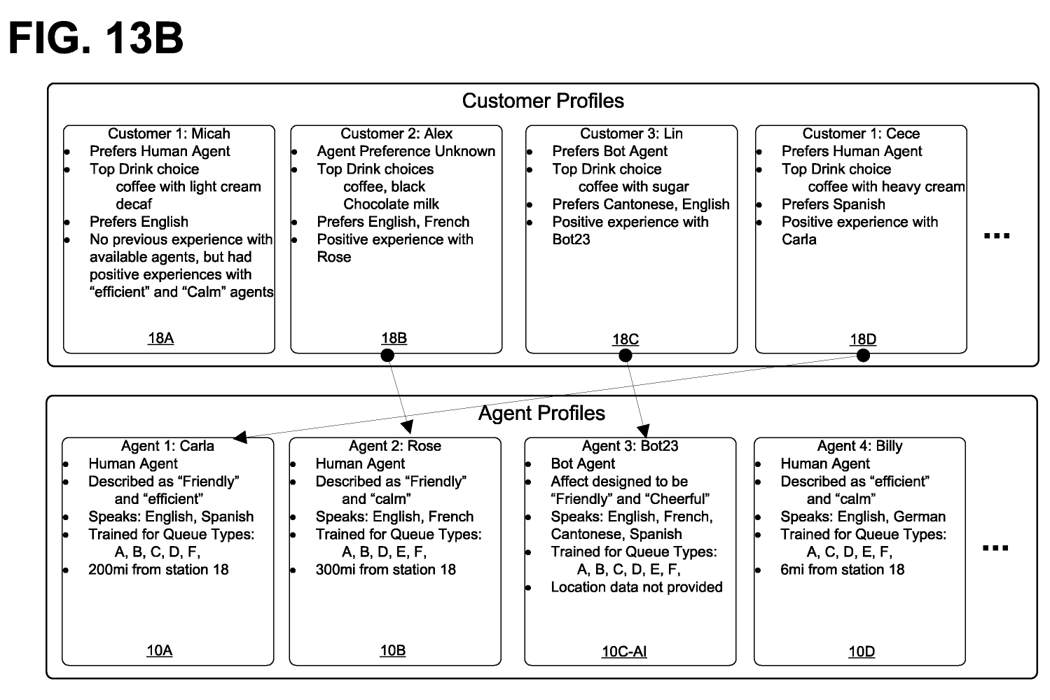

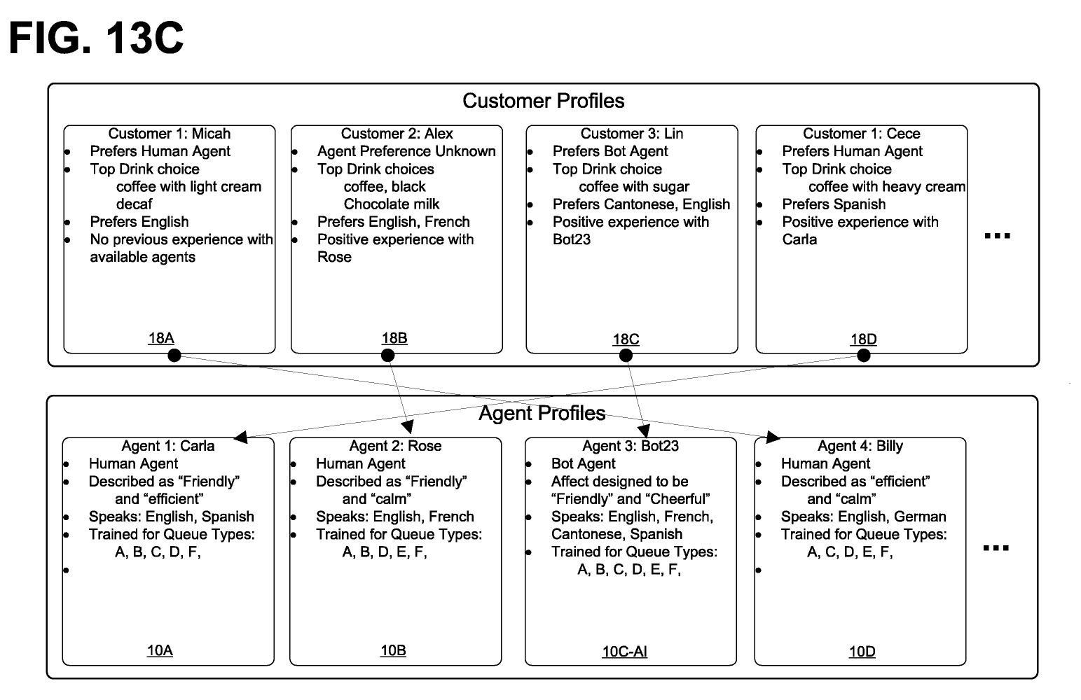

Turning now to FIGS. 13A through 13C, an embodiment used in a scenario involving profile-based selection of interaction agents for servicing detected end users at interaction stations is shown and described below. In this embodiment, the distributed interaction system evaluates profiles 18 associated with detected end users and profiles associated with available agents in order to determine which agent device should service a particular interaction session. The system may analyze attributes stored within the profiles, including historical interaction records, language preferences, agent interaction preferences, training attributes associated with agents, and geographic information associated with prior interaction sessions. Based on this analysis, the system dynamically selects an interaction agent from a pool of available agent devices and establishes a communication connection between the interaction station and the selected agent device through the communication system 250. The selected agent may be a human-operated agent device, such as agent 11E, or an automated agent process executed by a computing system, such as agent 11A, depending on the attributes derived from the profile analysis.

FIG. 13A illustrates an embodiment in which the system retrieves and evaluates profiles 18 associated with detected end users approaching an interaction station positioned near a service location such as window 240. In this embodiment, each end user profile may include attributes such as language preferences, historical interaction records with particular agents, previously expressed preferences for interacting with human agents or automated agents, and records of prior interaction outcomes. The agent profiles may include attributes such as language capabilities, training certifications, agent type (e.g., human agent 11E or automated agent 11A), geographic availability, and historical feedback associated with previous interaction sessions. The resource allocation engine analyzes the profile attributes to identify which agents in the available agent pool are capable of servicing the detected interaction request and to determine which agent device is most compatible with the detected end user.

FIG. 13B illustrates an embodiment in which the system performs a profile-based matching process that prioritizes historical interaction relationships between end users and agents. In this example, the system determines from the profile data that the detected end user previously interacted successfully with a particular agent device. When positive interaction history exists between a user profile and a particular agent profile, the system may prioritize pairing the end user with that same agent device. Because agent devices communicate through the communication system 250, the selected agent may be located remotely from the interaction station while still maintaining a real-time communication connection with the station. In some embodiments, the selected agent may be a human-operated agent such as agent 11E, allowing the end user to interact with an agent with whom they have previously had a successful interaction session. This profile-based pairing improves interaction efficiency and reduces the need for repeated clarification during interaction sessions.

FIG. 13C illustrates an embodiment in which the system performs a profile-based matching process when a detected end user does not have prior interaction history with any currently available agents. In this situation, the system evaluates other attributes stored within the profiles 18 in order to determine a suitable match between the detected end user and an available agent device. These attributes may include language compatibility, training characteristics associated with agents, agent type, and geographic proximity between the agent and the interaction location. In some embodiments, the system may determine whether the interaction should be serviced by a human-operated agent device such as agent 11E or by an automated agent process such as agent 11A. For example, the system may determine from the user profile that the end user historically prefers interactions with human agents and may therefore select agent 11E. In other embodiments, the system may determine that automated interaction processing is appropriate and may select automated agent 11A executed on a computing system connected to the communication system 250.

In some implementations, the profile-based analysis may also incorporate geographic cluster information derived from multiple profiles 18 associated with users within a particular region. For example, the system may determine that users associated with a particular geographic region frequently interact successfully with human agents. When a newly detected end user is associated with that geographic cluster, the resource allocation engine may prioritize selection of a human-operated agent device from the available agent pool. Conversely, when users within a geographic cluster frequently complete interaction sessions using automated agents, the system may initially select an automated agent process such as agent 11A while maintaining the ability to transition the interaction session to a human-operated agent when appropriate.

Through this profile-driven matching process, the distributed interaction system dynamically allocates interaction resources by selecting between human-operated agent devices and automated agent processes based on attributes stored within profiles 18, historical interaction records, and geographic interaction patterns. This architecture allows interaction stations located near service areas such as window 240 to be supported by agent devices located at any network-accessible location through the communication system 250, thereby improving efficiency and resource utilization across the distributed interaction system.

The embodiments illustrated in FIGS. 13A–13C further demonstrate how the distributed interaction system dynamically selects an interaction agent from a pool of available agent devices based on attributes stored within profiles 18 associated with detected end users and available agents. As described above, the system may analyze historical interaction records, expressed interaction preferences, language attributes, training characteristics associated with agents, and geographic interaction patterns when determining whether to connect an interaction station to a human-operated agent device such as agent 11E or to an automated agent process such as agent 11A. Once the appropriate agent device is selected, the system establishes a communication session between the interaction station and the selected agent device through the communication system 250, thereby allowing the selected agent to interact with the end user through the interface components of the interaction station. These embodiments illustrate example implementations of the techniques described herein in which profile-based analysis and distributed communication infrastructure are used to dynamically allocate interaction resources across multiple interaction stations and agent devices.

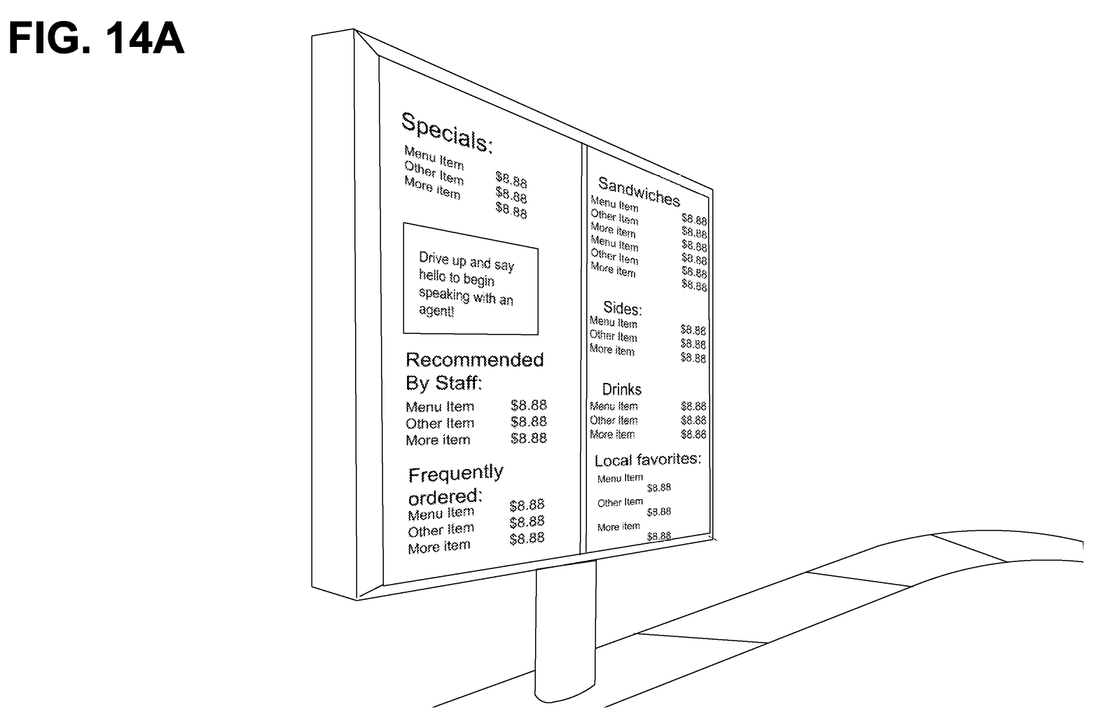

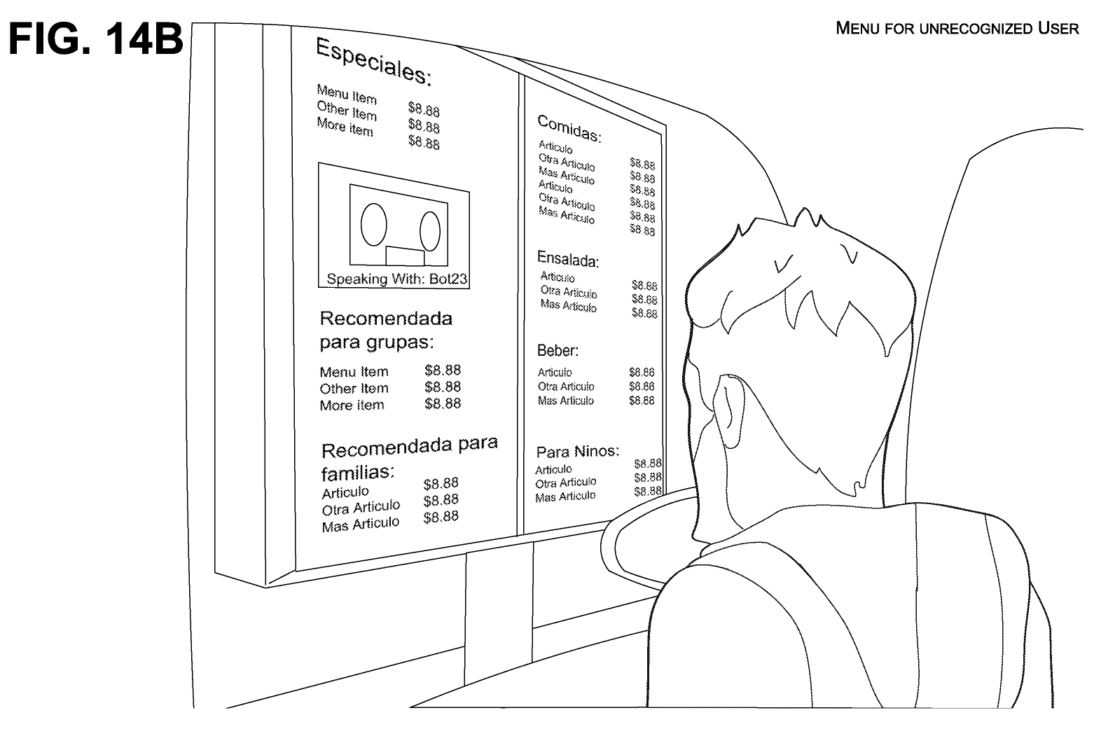

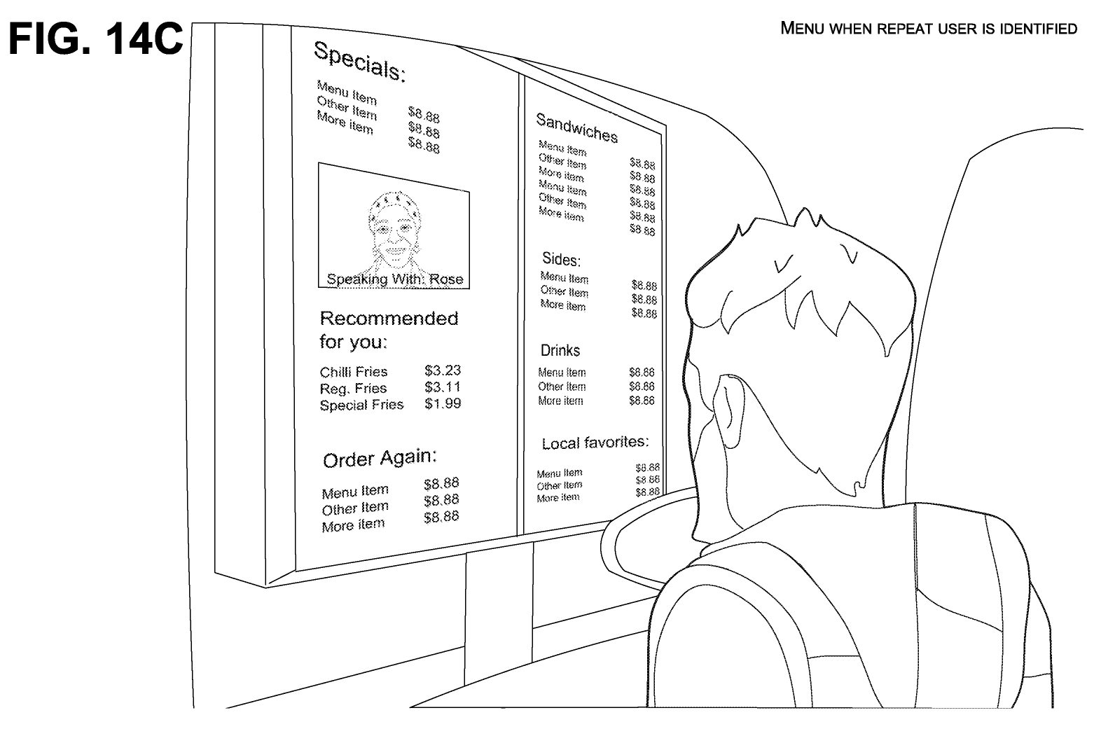

Turning now to FIGS. 14A through 14C, an embodiment used in a scenario involving operation of an interaction station display before and during interaction sessions with both unrecognized and recognized users is shown and described below. This example shows a personalized menu and a dynamic agent selection at an interaction station. In this embodiment, the station dynamically selects an interaction agent and modifies the displayed menu based on whether the approaching user is identified by the system. The system may detect identifying information through sensors positioned near the queue or interaction station, including cameras configured to analyze vehicle characteristics, license plates, or facial features, as well as microphones configured to analyze speech characteristics. Based on this information, the system determines whether a stored user profile is associated with the detected user and then selects an interaction agent accordingly. The interaction station may communicate with the selected agent through the communication system 250, and the display of the station may be dynamically modified to reflect the selected agent and menu configuration.

FIG. 14A illustrates an embodiment of a display of the interaction station before a user arrives or before the system detects identifying information associated with the user. In this initial state, the display presents a default menu interface without personalized content associated with a specific user profile. The menu items shown may correspond to frequently ordered items or recommended selections associated with the location. The display may also present prompts encouraging the approaching user to begin an interaction session, such as a message instructing the user to speak to begin the ordering process. Because the system has not yet identified a particular user, the interface remains in a neutral configuration and does not display a selected agent or personalized recommendations.

FIG. 14B illustrates an embodiment in which a user arrives at the interaction station but the system is unable to associate the detected user with a stored user profile. In this situation, the system treats the user as an unrecognized user and assigns a default interaction agent. In the example shown in FIG. 14B, the system selects an automated agent process identified as Bot23, which is represented on the display by an icon and the text “Speaking With: Bot23.” The automated agent may be executed by a computing system connected to the interaction station through the communication system 250 and may be capable of supporting interactions across multiple languages.

Because the user is not recognized, the menu displayed in FIG. 14B may be presented in a first language, which may correspond to a default language associated with the location. In some embodiments, the default language may also be selected dynamically based on detected inputs associated with the approaching vehicle. For example, the system may analyze speech captured by a microphone associated with the station to determine the language spoken by the user or passengers within the vehicle. Alternatively, the system may determine the language by analyzing characteristics associated with the vehicle, such as a license plate identifier or geographic region associated with the vehicle registration. Based on these detected characteristics, the system may automatically select the most appropriate display language for the interaction session. Because the system has no historical profile information for the detected user, the displayed menu may present general recommendations such as items commonly ordered by groups or popular items at the location.

FIG. 14C illustrates an embodiment in which the system detects that the user corresponds to a returning user having an associated user profile stored within the system. The system may determine the identity of the user through sensor data such as license plate recognition, facial recognition, or other identifiers associated with the vehicle or user. When the user profile is identified, the system retrieves historical interaction records and preference data associated with that user. Based on the retrieved profile data, the system may determine that the user previously interacted successfully with a human-operated agent, and the system therefore switches the interaction from the automated agent to a human agent. In the example shown in FIG. 14C, the interface indicates that the user is now “Speaking With: Rose,” where Rose represents a human-operated agent device connected to the interaction station through the communication system 250.

In addition to switching the interaction agent, the system modifies the displayed menu to include personalized recommendations derived from the retrieved user profile. The personalized menu may highlight items that the user frequently orders or items that correspond to preferences stored within the user profile. In the example illustrated in FIG. 14C, the menu display may include recommended items tailored to the user, including “special fries for $1.99.” The language of the display may also change in FIG. 14C to a second language associated with the identified user profile. For example, if the system determines from the retrieved profile or detected speech characteristics that the user prefers a particular language, the display language may automatically switch to that language to improve interaction efficiency.

Through the embodiments illustrated in FIGS. 14A–14C, the system demonstrates how the interaction station dynamically selects between an automated agent and a human-operated agent based on whether the user is recognized and whether historical interaction records are available. The system further demonstrates how menu displays and interface elements may be dynamically modified based on detected language characteristics, user profile data, and historical interaction information, thereby improving the efficiency and personalization of interaction sessions at the station.

The embodiments illustrated in FIGS. 14A–14C further demonstrate techniques in which the system selects an interaction agent based on detected user characteristics and stored historical interaction data. As described above, the system may initially assign an automated agent process when a user is not recognized and may subsequently select a human-operated agent device when a stored user profile associated with the detected user is identified. The system may also dynamically modify the menu display presented at the interaction station based on the retrieved user profile, including displaying personalized recommendations and language settings corresponding to the user’s historical interaction preferences. These embodiments illustrate example implementations in which the distributed interaction system detects user identifiers, retrieves corresponding profile data, selects between automated and human-operated agents, and generates customized menu interfaces presented on a display of the interaction station while concurrently providing interaction context to the selected agent device through the communication system 250.

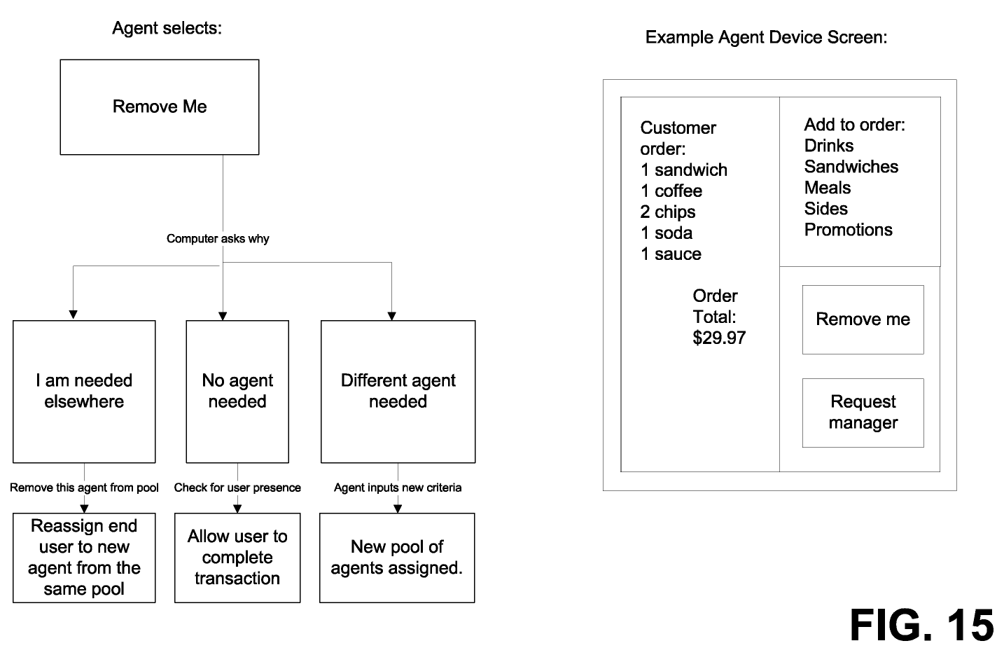

Turning now to FIG. 15, an embodiment used in a scenario involving operation of an agent device interface during an active interaction session is shown and described below. In this embodiment, a computing device operated by a human agent presents an interface that allows the agent to manage an interaction session with an end user located at an interaction station, such as a drive-through station or counter-top ordering terminal. The agent device communicates with the interaction station through the communication system 250, allowing the agent to receive audio from the station, transmit responses to the user, and manage items associated with an order transaction. The interface also provides controls that allow the agent to modify the order, add additional items, or initiate reassignment of the interaction session to another agent within the agent pool.

FIG. 15 illustrates an example display presented on an agent device during an active interaction session. In the embodiment shown, the interface displays an order summary panel that lists items currently associated with the user’s order. Example items shown in the figure include a sandwich, coffee, chips, soda, and sauce, along with a displayed order total. The interface also provides selectable menu categories that allow the agent to add items to the order, such as categories for drinks, sandwiches, meals, sides, and promotional items. Through this interface, the human agent may update the order in real time while communicating with the user through the interaction station.

The interface further includes controls allowing the agent to indicate that they should be removed from the interaction session. For example, the agent may select an option labeled “Remove Me,” which causes the system to request additional information regarding the reason for the removal. The interface may present selectable reasons such as the agent being needed elsewhere, a determination that no agent is required for the remainder of the transaction, or a request for a different agent with particular qualifications.

Based on the selected reason, the distributed interaction system may perform different reassignment operations. In some embodiments, the system may reassign the end user to another agent selected from the same pool of available agents. In other embodiments, the system may remove the current agent from the agent pool and select a replacement agent that satisfies additional criteria. For example, the system may select a replacement agent having particular language capabilities, training attributes, or historical interaction compatibility with the detected user. In some cases, the system may determine that the interaction can continue using an automated agent process, allowing the transaction to proceed without human intervention. In other embodiments, the system may request approval from a manager device before performing the reassignment.

Through the interface illustrated in FIG. 15, the distributed interaction system enables dynamic management of interaction sessions while maintaining the ability to reallocate agent resources in real time. This capability allows the system to preserve efficiency within the agent pool while ensuring that users interacting with stations connected through the communication system receive appropriate assistance throughout the transaction.

The embodiment illustrated in FIG. 15 further demonstrates how the distributed interaction system dynamically manages computational and human interaction resources during an active interaction session. When an agent operating the agent device indicates that the interaction should be reassigned, the system evaluates available agents within the agent pool and determines whether a replacement human agent or an automated agent process should be assigned to the interaction session. This reassignment process may be performed without interrupting the communication channel between the interaction station and the system because the interaction station remains connected through the communication system 250 while the backend system selects and connects a replacement agent device. In some embodiments, the system may evaluate attributes associated with the detected user, including historical interaction data stored within profiles 18, language characteristics, or geographic cluster patterns associated with users in the region. Based on this evaluation, the system may select a new agent device that better matches the characteristics associated with the user. By dynamically reallocating agent resources during an interaction session, the system improves utilization of agent devices, reduces latency associated with agent availability, and allows interaction stations connected to the distributed system to continue operating efficiently even as agents enter or leave the pool of available agents.

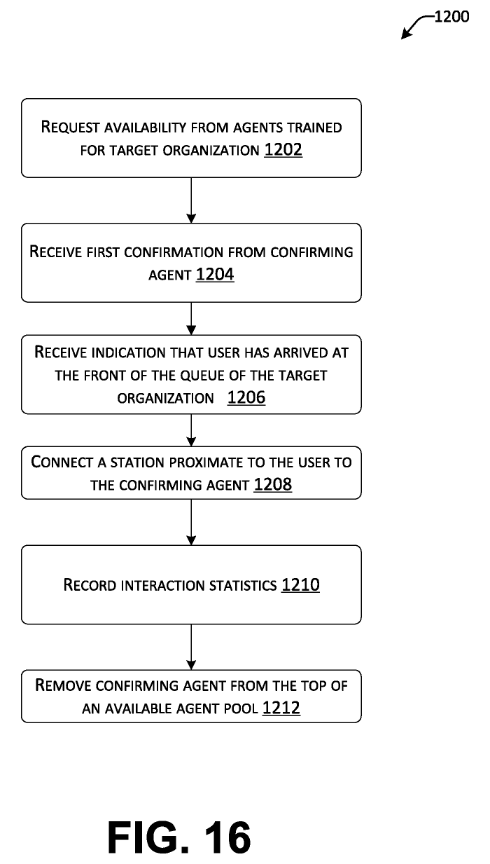

Turning now to FIG. 16, aspects of a routine for shared resource allocation for multiple queue processing is shown and described. The operations of FIG. 16 described below may be implemented. For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

With reference to FIG. 16, routine 1200 begins at operation 1202, where a plurality of availability requests 702 are sent to a plurality of agents 104 that are trained for a target organization 110A. When a location receives an indication that a customer is present, e.g., a car is detected by a drive-through sensor, the system may identify a subset of agents from a pool of agents that are qualified to service that particular location. The system can analyze a database of skill sets of each agent and select agents who have a skill set that matches the skill set requirements of that location. The system can communicate work requests to the predetermined number of agents, and the agent who first provides a confirmation to the first work requests, is selected as the on-deck agent.

Next at operation 1204, a first confirmation 704 is received from a first agent 104C to confirm availability for the target organization 110A. The first agent 104C to respond may be referred to as the “on-deck” agent and will be assigned to the next user that enters an empty queue 340.

Next at operation 1206, an indication that a user 320A has arrived at the front of the queue 340 of the target organization 110A is received. The user 320A may arrive at the front of any queue 340 at any location of the target organization 110A, allowing the on-deck agent 104C to help users at more than one location.

Next at operation 1208, the on-deck agent 104C is connected to a station (310A) proximate to the user 320A. The agent may guide the user through an ordering process or explain to the user procedures for completing orders for a restaurant or request for medical services, among other services.

In operation 1208, a system may utilize artificial intelligence (AI) features for assisting agents in taking orders. In such embodiments, a menu could be accessed by the system. Then, by the use of one or more AI models, the system can use the menu items to help an agent populate an order and/or verify whether the entries are correct. The system can monitor the voice signal of the end user, and by the use of a voice to text translation and by the use of the output of the AI model, the system can populate the order entry for the agent. The agent can then either accept the recommendation or deny it. In addition, the system can use the output of the AI model to help the agent with line completion for text entries. The AI model can be improved based on the agent’s feedback.

In general, the routine can include receiving an indication 506 that a user 320A has arrived at a queue 340 of a target organization 110A; in response to the indication 506 that the user 320A has arrived at the queue 340, sending a plurality of availability requests 702 to a plurality of agents 104 trained 304 for the target organization 110A; receiving an availability confirmation 704 from an agent 104C of the plurality of agents 104; and in response to receiving the availability confirmation 704 from the agent 104C, allocating the agent 104C to a station 310A proximate to the user 320A, wherein the system provides an audio connection between a portable device associated with the agent 104C and the station 310A that is proximate to the user.

In other embodiments, an AI model may be utilized in providing order recommendations using a customer’s order history. For example, if a user is ordering an ice cream cone with a number of toppings, AI model can provide recommendations based their order history or based on order histories of other customers. In some instances, the AI model can provide recommendations based on order histories of other customers having similar profiles.

In another example, the system can use facial recognition or license plate recognition to provide order recommendations. For example, if the system recognizes a user by the use of facial recognition or license plate recognition, the system will provide the agent with the user’s information, such as the user’s name, favorite sauces e.g., barbecue sauce, ranch, etc.), and how often the user visits the organization e.g., three times a week). The agent can then create a more personal connection with the user by knowing their preferences upon the user’s arrival. This allows a system to automatically populate a customer’s order that is based on the facial recognition or license plate recognition and by the use of that user’s order history. This can greatly shorten the amount of time a customer spends at any one station, particularly when an end user has a number of customizations to a menu item. This can also increase the efficiency of each agent as there are fewer mistakes and fewer manual data entry points.

The disclosed embodiments can utilize one of more types of language models to assist in the ordering process. A language model can be pre-trained utilizing a menu, user preferences, and/or order histories. This pre-training data enables the model to receive a natural language speech input describing menu items during the ordering process. For example, a menu can include a medium light roast coffee, large light roast coffee, medium dark roast coffee, large dark roast coffee, etc. The language model can generate model data associated with each menu item. The model data can draw associations and relationships between each menu item. This can include data indicating which item is lighter or darker than another item, or which item is larger or smaller than another item, etc. Using the order history, the model data can store keywords that a particular person has used for past orders. Thus, if a person uses “big” coffee and that led to an order with a large coffee, the system uses that keyword “big” for “large” sized items in future orders. This allows users to give a generic natural language suggestion of their order, e.g., "I would like to have a lighter coffee than my last order, but a larger size." The system can then access their history and determine that the last order was, for instance, a medium dark roast coffee. Using the voice input to the language model, the historical order data, and the model data, the system can receive a recommendation from the model, which in this case would be a large light roast coffee.

Each natural language voice input provided to a model can also be accompanied with a prompt for the model to provide a confidence level with each item recommendation. If the model returns a confidence level that is below a threshold, the system can activate a connection between an agent and the station associated with the user. If the confidence score is above the threshold, the system can provide that item recommendation to the user, which can be a text display or a voice output. If the user confirms the item recommendation, the system can add the recommended item to the user’s cart. In other embodiments, if the confidence score is above the threshold, the system can use that item recommendation to assist an agent, e.g., help the agent complete order forms, etc. The activation of the agent connection can also be invoked based on other criteria. For example, if the confidence score for a first voice input is below a threshold, the system may ask the user to provide the order again, or ask the user to clarify the order. If the system requires the user to repeat or refine their order more than a threshold number of order attempts, the system can connect the agent at that time.

Next at operation 1210, interaction statistics such as response time 542, interaction time 544, and an interaction metric 546 are captured and stored in response statistics database 540.

Next at operation 1212, the confirming agent 104C is removed from the top of the available agent pool 108.

The routine can also include operations for disconnecting the agent from the station in response to the detection of one or more events. When a queue is no longer associated with a particular agent, the process can be repeated. In subsequent iterations of the routine, the system may change the priority of Agents in a pool based on performance metrics or based on a first-in-line priority system.

In some configurations, a system can include a first camera having a first field of view and a second camera having a second field of view, the system causing a processor to: determine a user identity in response to a detection of a user in the first field of view of the first camera, wherein the first field of view is positioned such that a travel time for the user from the first field of view to the second field of view is greater than a predetermined time threshold, this gives the system time to retrieve the user’s order while the user is moving from the first camera to the ordering station; retrieving an order history and preferences of the user based on the user identity by accessing a database of customer records; and verifying the user identity by detecting the user in the second field of view of the second camera using the user identity, wherein the second field of view of the second camera is positioned in proximity to the ordering station, the second camera being in proximity of the ordering station when a microphone and speaker of the ordering station are close enough for the user to verbally communicate with a remote agent using the ordering station; in response to verifying the user identity by detecting the user in the second field of view of the second camera, causing a causing a display of the order history and/or the preferences in a display screen at the ordering station, wherein the display screen is positioned to enable the user to view the order history and/or the preferences, wherein the order history and/or the preferences are also displayed on a display screen of a remote device used by the agent in response to verifying the user identity by detecting the user in the second field of view of the second camera.

Efficient resource allocation is a goal of many organizations. For example, organizations that provide services to individuals waiting in queues often allocate one agent per queue. If the queues remain busy on a near continuous basis, then this allocation scheme is efficient. However, many service-based organizations experience lulls, creating a scenario in which agents remain idle for extended periods of time. Not only does this result in low efficiency and high expenses, but the agents working on behalf of the organization may become unfulfilled. In addition, agents who are not working at optimal levels of engagement also cause inefficient use of computing resources and network resources. The systems remain in use even though some agents are not working to their full potential or at consistent production levels.

In light of recent economic changes, organizations now struggle more with staffing and labor issues. For a company with more than one location, potentially up to thousands store locations, it may be difficult to for a company to acquire staffing for all locations and have that staff available at all peak hours. A franchise may have too many staff members at one location and not enough staff members at another location. Kiosk systems have been implemented to remedy this issue. However, kiosk systems can be restrictive and tend to be cumbersome and inefficient for end users, e.g., customers approaching a counter. The current state of the industry relies heavily on a touch screen design, which limits a user’s interaction. This drawback greatly limits the help a kiosk can provide, particularly if an end user has questions about a menu. It is with respect to these and other considerations that the disclosure made herein is presented.

Based on some existing systems, there exists a need for improved computerized systems capable of coordinating interaction stations with pools of available agents in a manner that more efficiently utilizes both human-operated agents and automated agents. There is also a need for systems that can analyze sensor data associated with an approaching end user, retrieve historical interaction information associated with that end user, and dynamically select an appropriate agent for interacting with the end user. Additionally, improved systems are needed that can predict interaction preferences for previously unseen end users using patterns derived from groups of users exhibiting similar behavioral or geographic characteristics. Such systems may further improve interaction efficiency by providing context-specific information to both the interaction station and the selected agent device at the time the interaction begins. The systems and methods described in the present disclosure address these technical challenges and enable improved allocation of interaction resources within distributed computing environments.

In some configurations, the techniques disclosed herein provide systems for allocating shared resources in service queues. Agents are dynamically allocated to process orders of end users waiting in queues of an organization. Agents may be allocated to a queue located at one of a number of locations of a number of organizations. For example, an agent may be assigned to a queue to take an order from an end user at the top of the queue at a drive-through restaurant. Agents may be trained to perform any task for end users in a queue, which may also include, but is not limited to, taking orders at a drive-through restaurant, providing medical care at a drive-through clinic, taking orders at a front counter, or over a phone, etc. A system can connect one or more agents to a queue and allow selected agents to communicate with end users to fulfill their requests. The selected agents can maintain their connection with a particular queue until one or more predetermined events are detected, e.g., when there are no more end users in the queue, when selected agent requests to be removed, etc. When a predetermined event is detected, the selected agent is disconnected from an assigned queue. When a selected agent submits a request to be removed from a queue, that agent is replaced with a substitute agent that is selected using the processes described herein.

In some configurations, the system can apply different priorities to each queue for agent assignments based on a type of queue. There are several different types of queues, which can include, but is not limited to: a drive-thru queue, a counter queue, and a teleconferencing queue. The drive-thru queue can include any type of setup that serve customers in their motor vehicles. The counter queue can include any type of setup that serves customers in a building, The teleconferencing queue can include virtual meetings or phone calls from customers arranging a delivery or a pickup. In one embodiment, all types of queues have the same priority when agents are assigned. The agents are assigned to each queue on a first come, first served basis regardless of the type of queue that customers are detected. In other embodiments, the algorithm assigns a different priority to each type of queue. For instance, the system may prioritize a drive-thru queue over a teleconferencing queue, and prioritize the teleconferencing queue over a counter queue. In such an example, when a customer approaches a drive-thru, the assumption is that the user is in a hurry. Whereas a customer at a counter or a customer on a phone may not be in as much of a hurry compared to customers in a car. Thus, in such embodiments, if there are multiple customers waiting in each queue, the system would assign an available agent to drive-thru queue before the other types of queue.

To facilitate some of the above-described embodiments, a hardware sensor is used at the counter queues and/or the drive-thru queues. In such embodiments, the MQTT protocol may be used to notify agents that a user is present at a restaurant drive-thru or front counter. Eligible agents are informed in response to the detection of an end user and an audio system starts an audio connection between the current customer and the agent.

Agents may be selected and allocated to a particular queue in response to the detection of an end user entering a queue. When an end user approaches the queue, a sensor detecting the presence of the end user can cause the system to send work requests to a predetermined number of available agents. For instance, a number of available agents can be prioritized in an agent pool. Those agents can be prioritized using one or more factors including, but not limited to, performance metrics, first-in-line ordering, etc. In one illustrative example, if an available agent pool has five hundred available agents, the system may send work requests to the first three available agents based on their priority. The system can be configured to receive confirmations from each agent that receives a work request. The first available agent that provides a confirmation is selected as the primary agent that is to communicate with end users located at the queue.

Once an agent has been assigned to a queue, the agent is removed from the agent pool in response to the detection of a predetermined event. The agent may be connected to the system to communicate with an end user in the queue and provide services for the end users in the queue until the queue empties. When the system determines that a queue is empty, e.g., there are no more cars in the drive-through line, the agent is removed from the queue and the system disconnects the agent's communication with a communication station associated with the queue. When an agent is removed from a queue, that particular agent may be returned to the agent pool. When an agent is returned to the agent pool, in some embodiments, those agents are prioritized according to their performance metrics, or they may be positioned at the end of a line when a first-in-line model is utilized. An agent may also request to leave the queue. In such scenarios, the system can utilize the above-described process to select a new agent from the available agent pool before the agent is released from the queue.

In some embodiments, the sensors placed proximate to physical queue entry points can be upgraded to identify specific repeat end users rather than simply detecting the presence of unspecified end users. This can be done through the use of license plate readers to identify cars entering drive-thru queues or facial recognition software attached to camera sensors at counter and kiosk queues. When a repeat user is identified entering a queue, the system can reconfigure the priorities by which the agents are selected to match known preferences or needs of the identified repeat end user. The reconfigured priorities for agent assignment in sending availability requests to only agents who have more specialized training or language skills in order to meet the needs of the user, or sending availability requests first to these specific agents and then to other available agents, depending on the number of agents matching these requirements in the greater pool of agents. This can occur either following the recognition of the user entering the queue or at the user interface station itself, and could result in two people in line, one after the other, having different agents handle their transactions.

Concurrently, the system can also reconfigure portions of the visual display attached to the user interface station to fit any needs or preferences the user had implied or expressed during their previous interactions with the system. Changes to the visual display would include at least one of: personalized recommendations, a list of items previously ordered by the user, warnings about ingredients that may conflict with the user’s dietary restrictions, translations into one or more of the user’s most frequently used languages, nutrition information, promotions, and warnings of shortages and delays for specific items and preparations. For example, a user who had previously requested non-dairy substitutes for cream in their coffee would be given warnings about which menu items contain dairy, which cannot be made without diary, and which require additional preparation time to be made without dairy, all on the display when they are ordering. Another user with no known dietary restrictions might simply receive recommendations for items similar to the ones they had previously with a description, in their preferred language, about the item.

In some embodiments, a system can control a position for each end user, e.g., each customer, within a queue. For example, for a teleconferencing queue, an end user may opt out of the queue for a predetermined amount of time, if they need more time to decide what to order. The system can receive an input from the end user, e.g., a voice command or a manual input to an input device, indicating an inactive status for the queue. The input can include a time for the inactive status. In some embodiments, the inactive status can be invoked in response to the system detecting a pause in communication. A detected pause for a predetermined time period causes a user to move into an inactive status for a time period, an “indicated time.” In one specific example, an active period can be a predetermined time period, e.g., 5 minutes. The system can re-insert that end user into the queue after the indicated time has passed.

While the end user is in an inactive status, the system can send a prompt to the end user, prompting the end user to provide an updated status. In response, the system can receive an update indicating the end user wants to continue in the queue, or system can receive an update indicating the end user wants to drop from the queue. The user can choose to remain in the queue or opt out entirely. The prompt can be sent in response to one or more events. The event can include detection of the end user being in a next-in-line position, e.g., second place in line.

The system can also provide agent training tools and agent management tools. These tools include customized online courses and systems for monitoring the progress of each agent taking the online courses. The system monitors the progress of each agent, and automatically grants permissions for each agent to join an agent pool or one or more queues of a particular organization or certain queues within an organization based on the completion of predetermined training milestones. The system provides online courses that allow the agents to become trained for specific locations, e.g., specific restaurants. This allows organizations to require specific courses for a particular location, a specific queue, or a specific set of queues. The online courses provide simulated customer-agent interactions that allow the agents to practice orders using actual menus used at particular locations.

The system also automatically measures several performance metrics for the online courses, including speed and accuracy metrics for simulated orders. The system also automatically upgrades an agent’s skill level to more complex orders as the agent learns the software. When an agent meets a threshold performance metric for a course required for a location or a queue, that agent is allowed to join a pool for that location or a specific queue for a particular location. Then, that agent is eligible to be selected to interact with end users, e.g., customers, by the use of the other queuing techniques disclosed herein. By the use of these tools, before any agent’s first shift, they have already learned the menu, practiced taking orders, and developed the trained reactions for a particular location. This system allows for scalability as well, since a large number of agent candidates can be trained and managed using automated training methods.

The training tools also provide administrative features that allow admin users, e.g., location managers, to oversee agent pools. The system provides a user interface (UI) that shows lists agents who have completed predefined training tasks and who have been added to agent pools for a particular location, including which of these agents have special permissions or additional language skills. This UI allows a manager to see which agent is available for a pool, and tools for allowing the manager to assign agents to pools, or allows the manager to confirm agents who are recommended to specific pools. Managers would then be able to add agents under their supervision to applicable pools, request additional agents from other locations, or offer excess agents to pools under the supervision of other managers. This would allow for franchise or location specific pools of agents to still make use of available agents across the entire organization without overburdening any subsystem or manager. This would also allow managers to suggest trainings to any agents who are not currently busy or to more closely monitor any agents preforming their first real transaction following a training, and to receive warnings when manager permissions may be required in a transaction.

The system can generate a UI showing information about each agent and their association with any assigned queues. The UI can also show representations of individual locations, e.g., restaurants, and user interface stations within each location for each manager. . Managers can remove agents from a queue or add agents into a queue. The system can provide a notification to a manager if a minimum threshold of agents is reached, e.g., there are not enough assigned agents in a queue. A minimum threshold is the number of agents needed in a queue to ensure that the system is operating as efficiently as possible. The agents can be manually added to a queue, or the system can automatically allocate agents as needed to fulfill a minimum threshold of agents. The system can also allow managers to approve or decline any new agent that is automatically added to a queue. This allows the system managers to oversee a large number of organizations, locations, and individual stations at each location.

One iteration of the system grants each manager permission to access active agent transactions and agent device connections. This allows each manager to oversee an interaction via both the agent device and the station if any issues arise. For example, the system can provide a manager with an input control that removes an agent from a particular station if the agent is having connectivity issues or if they are encountering other customer interaction issues. Managers would then be able to assign themselves as an agent to complete the transaction or assign a new agent from the available agent pool.

By dynamically connecting agents to a queue and disconnecting agents in response to particular events, a system can provide a seamless, consistent customer service experience while allowing an organization to maintain a reduced number of active agents versus a number of agents that is normally required by traditional drive-through systems. For example, by the use of the techniques disclosed herein, a restaurant chain can staff 20,000 individual franchise locations using 5,000 to 15,000 agents who are dynamically allocated and re-allocated to queues at each location. This can greatly improve efficiency and utilization of a number of resources, including human resources and computing resources, versus traditional systems. Traditional systems require at least one agent fully dedicated to each franchise location, and traditional systems can involve processes where each agent and their associated systems have hours of idle time per day. Additionally, the same pool of agents is used for all the different types of agent queues, further improving the efficiency of these organizations.

In some configurations, a pool can be assigned to a select set of queues. This can include all queue types, e.g., counter queues, drive-thru queues, and teleconferencing queues. In addition, the pool can be assigned queues at different site locations. This allows agents assignments to jump from city to city within the same organization or even within different companies. This allows a group of agents to serve in queues and locations where they are needed most and times where they are needed. For example, an agent may take an order at a pizza shop in Oakland, CA from a front counter, then be immediately reassigned to take an order at an Italian restaurant in Arlington, VA from a drive-thru. These features allow managers to assign agents to queues and locations and companies based on their trained skillset. In addition, the disclosed features also allow managers to utilize a smaller number of agents to service locations in different time zones. This allows one set of agents to work with several workload waves, e.g., multiple lunch rushes. In another example, a single company, for example, a mom-and-pop restaurant with one location, can be put in the same queue as other similar shops. The agents provide an opportunity for these organizations to greatly reduce the number of people needed to staff a smaller company. For example, instead of needing ten people for ten locations, a manager could have three people running those ten locations, even though the locations are associated with different companies.

The system provides live video and audio feeds of an agent to each customer station. The live video feeds of each agent provide more efficiency to an organization than a typical kiosk because the end user is able to make a visual and audio connection with an agent. Being able to see the face of the agent helps each end user, e.g., each customer, have a better customer service experience, and it also helps with the speed and accuracy of each order. Agents allow a user to ask questions, a feature that most kiosks may not be able to provide.

In some embodiments, a system may utilize artificial intelligence (AI) features for assisting agents in taking orders. In such embodiments, a menu could be accessed by the system. Then, by the use of one or more AI models, the system can use the menu items to help an agent populate an order and/or verify whether the entries are correct. The system can monitor the voice signal of the end user, and by the use of a voice to text translation and by the use of the output of the AI model, the system can populate the order entry for the agent. The agent can then either accept the recommendation or deny it. In addition, the system can use the output of the AI model to help the agent with line completion for text entries. The AI model can be improved based on the agent’s feedback.

In other embodiments, an AI model may be utilized in providing order recommendations using a customer’s order history. For example, if a user is ordering an ice cream cone with a number of toppings, AI model can provide recommendations based their order history or based on order histories of other customers, to provide lists of topping and flavor combinations that the user might like. In some instances, the AI model can provide recommendations based on order histories of other customers with similar circumstances, using details such as the geographic location, how many people are accompanying the user, the presence of children, and contents of previous orders.

In another example, the system can use facial recognition or license plate recognition to provide order recommendations. For example, if the system recognizes a user by the use of facial recognition or license plate recognition, the system will provide the agent with the user’s information, such as the user’s name, favorite sauces (e.g., barbecue sauce, ranch, etc.), and how often the user visits the organization (e.g., three times a week). The agent can then create a more personal connection with the user by knowing their preferences upon the user’s arrival. This allows a system to automatically populate a customer’s frequently ordered list that is based on the facial recognition or license plate recognition and by the use of that user’s order history. This can greatly shorten the amount of time a customer spends at any one station, particularly when an end user has a number of customizations to a menu item. This can also increase the efficiency of each agent as there are fewer mistakes and fewer manual data entry points.

The use of a user’s interaction history can also provide warnings to agents regarding dietary restrictions, such as adding a warning to the user profile regarding a potential dairy sensitivity in response to the user frequently requesting soy or nut based milk alternatives. The warning would then appear to the agent so that they can inform the user when dairy is present in a dish they are attempting to order, and the system could then suggest order customizations or alternate dishes based on the same model as other dish recommendations to give the user.

The disclosed system addresses the technical problem of computing resource efficiencies and security issues. The disclosed system solves these technical problems by providing control of audio signals and video signals that are connected and disconnected in response to the detection of one or more specific events. For instance, by selecting a subset of agents prior to a single agent accepting an agent request, the system can cause an automatic connection that can reduce computing cycles, memory usage and network bandwidth by providing a connection between an agent and a station without user input for selecting or connecting the agents to the stations. Secure connections that are disconnected in response to the detection of one or more specific events also help avoid cross talk and the communication of information to users and agents that are not part of the same order. Agents are disconnected at appropriate times for avoiding confusion between different end users. Security of information, particularly in a drive-up medical station, is improved by the timing of when audio and video connections are connected and disconnected.

The disclosed embodiments may be implemented as distributed computing systems in which interaction stations, sensing devices, agent devices, and server systems communicate over one or more networks to dynamically allocate interaction resources based on processed sensor data and historical interaction information.

In some embodiments, a computer-implemented method for controlling communication between a user located at a station with an agent selected from a pool of agents based on preferences of the user, the method for execution on a system, the method comprising: receiving video data from a sensor depicting at least one identifiable characteristic of the user or a vehicle of the user; identifying a profile for the user based on the video data depicting the at least one identifiable characteristic of the user or the vehicle of the user; and as shown in FIG. 13B where it shows finding the user preferences, the system can analyze the profile to determine one or more preferences of the user, the one or more preferences identifying a first preference for an agent type (human agent or an AI bot, language, agent from a geographic region, etc.) and a second preference for a product type or product identification (drink type, toppings etc.); select the agent from the pool of agents using the one or more preferences of the user; establishing an audio connection between a portable device associated with the agent and the station associated with the user; routing secure transaction data for an order of the user from the station to a secure transaction server without exposing the secure transaction data to the portable device associated with the confirming agent; and disconnect the agent from the station, by automatically disconnecting the audio connection between the portable device associated with the agent and the station associated with the user.

In some embodiments, the one or more preferences further comprises a third preference identifying a dietary restriction of the user, wherein the method further comprises selecting a menu set for the dietary restriction. In some embodiments, the method further comprises display a first menu (default) selecting a first menu from a pool of menus each having different languages; display selected menu (display second menu). In some embodiments, the selection of the agent from the pool of agents includes a selection of a human agent or an AI agent with the necessary training for the location and queue type the user is at, based on the preferences of the user. In some embodiments, the plurality of availability requests is limited to a predetermined number of requests that is based on a number of the agents in a pool of available agents. In some embodiments, the method further comprises receiving an exit request from the portable device associated with the agent, the exit request initiating operations to disconnect the audio connection between the portable device associated with the agent and a speaker and microphone of the station; and in response to the exit request, initiating operations to disconnect the audio connection between the portable device associated with the agent and a speaker and microphone of the station.

In some embodiments, the method further comprises sending a predetermined number of availability requests to one or more agents of the plurality of agents; receiving a second availability confirmation from a second agent of the plurality of agents; and in response to receiving the second availability confirmation from the second agent, allocating the second agent to the station proximate to the user, wherein the system provides an audio connection between a second portable device associated with the second agent and other end users in proximity to the station.

In some embodiments, the system uses license plate and facial recognition sensors to identify a user comprising: receiving user identification from a field of view 1 that senses a user when they first enter the queue, and receiving a field of view 2 identification from that senses a user when they arrive at the station. In some embodiments, a manager device oversees the agent profiles and permissions throughout the course of the agent’s shift. In some embodiments, the manager device adds or removes an agent when the number of agents does not meet an agent pool size threshold. In some embodiments, the manager device enters the queue with the agent during a user’s transaction with the queue. In some embodiments, a computing device comprises: one or more processing units; and a computer-readable storage medium having encoded thereon computer-executable instructions to cause the one or more processing units to: receive an indication 506) that a user 320A) has arrived at a queue 340) of a target organization 110A); in response to the indication 506) that the user 320A) has arrived at the queue 340), send a plurality of availability requests 702) to a plurality of agents 104) trained 304) for the target organization 110A); receiving an availability confirmation 704) from an agent 104C) of the plurality of agents 104); and in response to receiving the availability confirmation 704) from the agent 104C), allocating the agent 104C) to a station 310A) proximate to the user 320A), wherein the system provides an audio connection between a portable device associated with the agent 104C) and the station 310A) that is proximate to the user. In some embodiments, the system maintains the connection between the agent and the station until one or more sensors detect that no other users are in proximity to the queue at the target organization, wherein the instructions further cause the one or more processing units to: receive a signal from the one or more sensors indicating that no other users are in proximity to the queue; and disconnect the audio connection between the portable device associated with the agent and a speaker and a microphone of the station in response to receiving the signal from the one or more sensors indicating that no other users are in proximity to the queue. In some embodiments, plurality of availability requests is limited to a predetermined number of requests that is based on a number of the agents in a pool of available agents. In some embodiments, the instructions further cause the one or more processing units to: receive an exit request from the portable device associated with the agent, the exit request initiating operations to disconnect the audio connection between the portable device associated with the agent and a speaker and microphone of the station; and in response to the exit request, initiate operations to disconnect the audio connection between the portable device associated with the agent and a speaker and microphone of the station. In some embodiments, the instructions further cause the one or more processing units to: send a predetermined number of availability requests to one or more agents of the plurality of agents; receive a second availability confirmation from a second agent of the plurality of agents; and in response to receiving the second availability confirmation from the second agent, allocate the second agent to the station proximate to the user, wherein the system provides an audio connection between a second portable device associated with the second agent and other end users in proximity to the station. In some embodiments, the system serves users in a drive-thru queue, a front counter queue, or a phone queue. In some embodiments, the system uses license plate and facial recognition sensors to identify a user comprising: receiving user identification from a field of view 1 that senses a user when they first enter the queue, and receiving a field of view 2 identification from that senses a user when they arrive at the station. In some embodiments, a manager device oversees the agent profiles and permissions throughout the course of the agent’s shift. In some embodiments, the manager device adds an agent when the number of agents does not meet a minimum threshold.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented 1) as a sequence of computer implemented acts or program modules running on a computing system and/or 2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 1200 are described herein as being implemented, at least in part, by modules running the features disclosed herein can be a dynamically linked library DLL), a statically linked library, functionality produced by an application programing interface API), a compiled program, an interpreted program, a script, or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 1200 may be also implemented in many other ways. For example, the routine 1200 may be implemented, at least in part, by a processor of another remote computer or a local circuit. In addition, one or more of the operations of the routine 1200 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

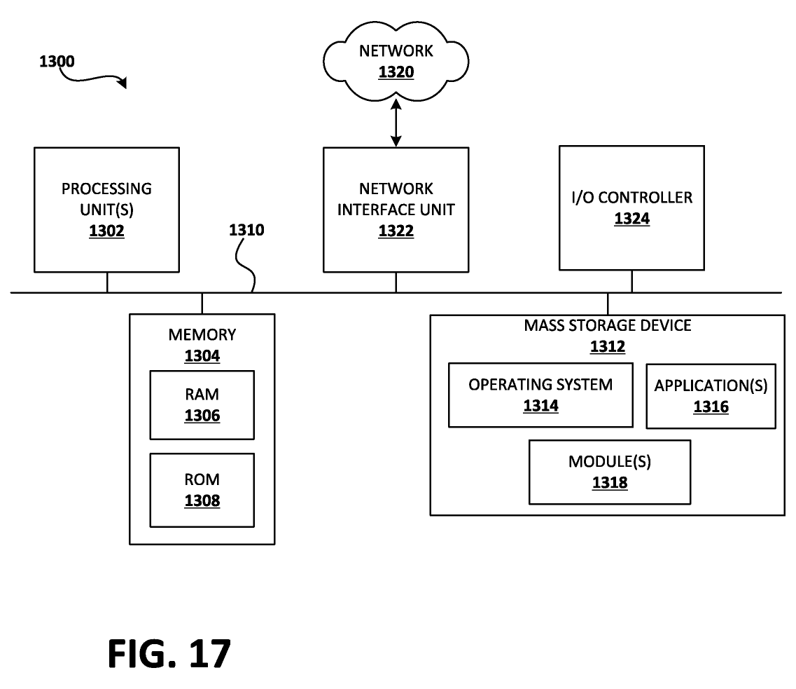

FIG. 17 shows additional details of an example computer architecture 1300 for a device, such as a computer or a server configured as part of the systems described herein, capable of executing computer instructions e.g., a module or a program component described herein). The computer architecture 1300 illustrated in FIG. 16 includes processing units) 1302, a system memory 1304, including a random-access memory 1306 “RAM”) and a read-only memory “ROM”) 1308, and a system bus 1310 that couples the memory 1304 to the processing units) 1302.

Processing units), such as processing units) 1302, can represent, for example, a CPU-type processing unit, a GPU-type processing unit, a field-programmable gate array FPGA), another class of digital signal processor DSP), or other hardware logic components that may, in some instances, be driven by a CPU. For example, and without limitation, illustrative types of hardware logic components that can be used include Application-Specific Integrated Circuits ASICs), Application-Specific Standard Products ASSPs), System-on-a-Chip Systems SOCs), Complex Programmable Logic Devices CPLDs), etc.

A basic input/output system containing the basic routines that help to transfer information between elements within the computer architecture 1300, such as during startup, is stored in the ROM 1308. The computer architecture 1300 further includes a mass storage device 1312 for storing an operating system 1314, applications) 1316, modules 1318, and other data described herein.

The mass storage device 1312 is connected to processing units) 1302 through a mass storage controller connected to the bus 1310. The mass storage device 1312 and its associated computer-readable media provide non-volatile storage for the computer architecture 1300. Although the description of computer-readable media contained herein refers to a mass storage device, it should be appreciated by those skilled in the art that computer-readable media can be any available computer-readable storage media or communication media that can be accessed by the computer architecture 1300.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory RAM), static random-access memory SRAM), dynamic random-access memory DRAM), phase change memory PCM), read-only memory ROM), erasable programmable read-only memory EPROM), electrically erasable programmable read-only memory EEPROM), flash memory, compact disc read-only memory CD-ROM), digital versatile disks DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 900 may operate in a networked environment using logical connections to remote computers through the network 1320. The computer architecture 1300 may connect to the network 1320 through a network interface unit 1322 connected to the bus 1310. The computer architecture 1300 also may include an input/output controller 1324 for receiving and processing input from a number of other devices, including a keyboard, mouse, touch, or electronic stylus or pen. Similarly, the input/output controller 1324 may provide output to a display screen, a printer, or other type of output device.

It should be appreciated that the software components described herein may, when loaded into the processing units) 1302 and executed, transform the processing units) 1302 and the overall computer architecture 1300 from a general-purpose computing system into a special-purpose computing system customized to facilitate the functionality presented herein. The processing units) 1302 may be constructed from any number of transistors or other discrete circuit elements, which may individually or collectively assume any number of states. More specifically, the processing units) 1302 may operate as a finite-state machine, in response to executable instructions contained within the software modules disclosed herein. These computer-executable instructions may transform the processing units) 1302 by specifying how the processing units) 1302 transition between states, thereby transforming the transistors or other discrete hardware elements constituting the processing units) 1302.

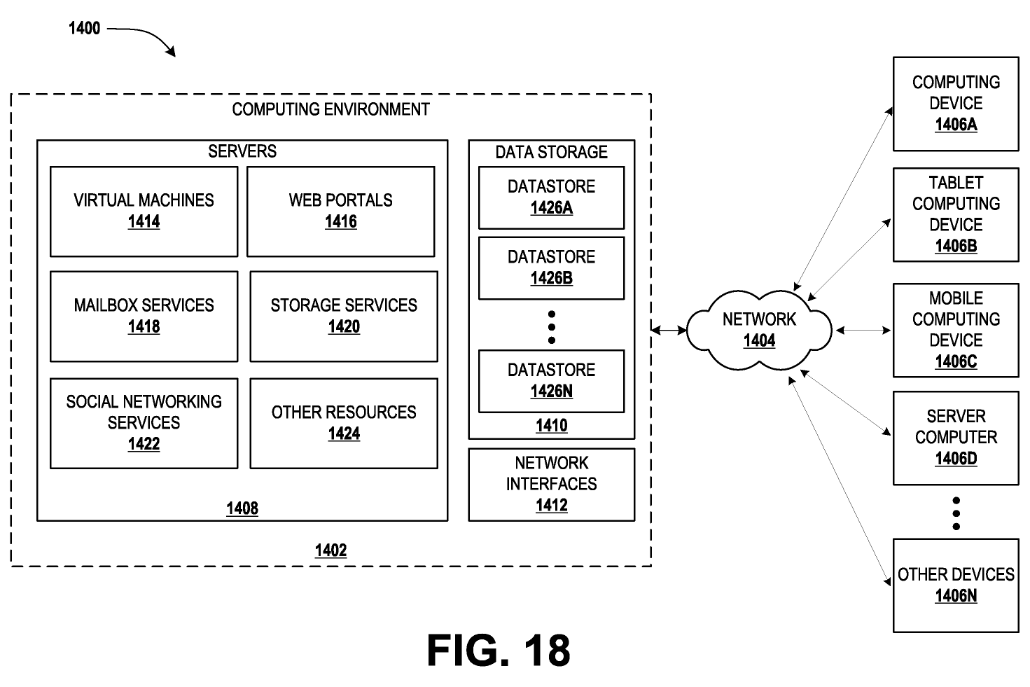

FIG. 18 depicts an illustrative distributed computing environment 1400 capable of executing the software components described herein. Thus, the distributed computing environment 1400 illustrated in FIG. 18 can be utilized to execute any aspects of the software components presented herein. For example, the distributed computing environment 1400 can be utilized to execute aspects of the software components described herein.

Accordingly, the distributed computing environment 1400 can include a computing environment 1402 operating on, in communication with, or as part of the network 1404. The network 1404 can include various access networks. One or more client devices 1406A-1406N hereinafter referred to collectively and/or generically as “clients 1406” and also referred to herein as computing devices 1406) can communicate with the computing environment 1402 via the network 1404. In one illustrated configuration, the clients 1406 include a computing device 1406A such as a laptop computer, a desktop computer, or other computing device; a slate or tablet computing device “tablet computing device”) 1406B; a mobile computing device 1406C such as a mobile telephone, a smart phone, or other mobile computing device; a server computer 1406D; and/or other devices 1406N. It should be understood that any number of clients 1406 can communicate with the computing environment 1402.

In various examples, the computing environment 1402 includes servers 1408, data storage 1410, and one or more network interfaces 1412. The servers 1408 can host various services, virtual machines, portals, and/or other resources. In the illustrated configuration, the servers 1408 host virtual machines 1414, Web portals 1416, mailbox services 1418, storage services 1420, and/or, social networking services 1422. As shown in FIG. 18 the servers 1408 also can host other services, applications, portals, and/or other resources “other resources”) 1424.

As mentioned above, the computing environment 1402 can include the data storage 1410. According to various implementations, the functionality of the data storage 1410 is provided by one or more databases operating on, or in communication with, the network 1404. The functionality of the data storage 1410 also can be provided by one or more servers configured to host data for the computing environment 1402. The data storage 1410 can include, host, or provide one or more real or virtual datastores 1426A-1426N hereinafter referred to collectively and/or generically as “datastores 1426”). The datastores 1426 are configured to host data used or created by the servers 1408 and/or other data. That is, the datastores 1426 also can host or store web page documents, word documents, presentation documents, data structures, algorithms for execution by a recommendation engine, and/or other data utilized by any application program. Aspects of the datastores 1426 may be associated with a service for storing files.

The computing environment 1402 can communicate with, or be accessed by, the network interfaces 1412. The network interfaces 1412 can include various types of network hardware and software for supporting communications between two or more computing devices including, but not limited to, the computing devices and the servers. It should be appreciated that the network interfaces 1412 also may be utilized to connect to other types of networks and/or computer systems.

It should be understood that the distributed computing environment 1400 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1400 provides the software functionality described herein as a service to the computing devices. It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1400 to utilize the functionality described herein for providing the techniques disclosed herein, among other aspects.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

Clause A: A computer-implemented method for dynamically allocating interaction resources within a distributed interaction system, the method comprising: receiving, at one or more computing systems, video data from a sensing device associated with an interaction station; processing the video data to detect an approaching end user and to extract one or more identity features associated with the end user; determining, using the one or more computing systems, whether historical interaction data is associated with the detected identity features; retrieving historical interaction records corresponding to the detected identity features when historical interaction data is determined to be associated with the end user; executing, by the one or more computing systems, a prediction model configured to determine a preferred interaction modality for the end user based at least in part on the historical interaction records; selecting, from a pool of available agent devices connected to the distributed interaction system, an interaction agent based on the preferred interaction modality determined by the prediction model, wherein the pool of available agent devices includes devices operated by human agents and automated agent processes executed by computing systems; establishing a communication session between the interaction station and a computing device associated with the selected interaction agent; and synchronizing contextual information derived from the historical interaction records to both: (i) a display associated with the interaction station, and (ii) the computing device associated with the selected interaction agent.

Clause B: the computer-implemented method of Clause A: wherein selecting the interaction agent further comprises: determining geographic location data associated with the detected end user based on at least one of sensor-derived vehicle information, network location information, or historical interaction location records; identifying a geographic cluster corresponding to the geographic location data; analyzing historical interaction records associated with prior end users within the geographic cluster to determine a regional interaction preference indicating that prior end users within the geographic cluster more frequently selected human-operated interaction agents than automated agent processes; in response to determining the regional interaction preference for human-operated interaction agents, selecting a computing device operated by a human agent from the pool of available agent devices instead of selecting an automated agent process; and establishing the communication session between the interaction station and the computing device associated with the selected human agent.

In certain embodiments, the distributed interaction system further evaluates geographic information associated with a detected end user when determining whether to connect the interaction station to a human-operated agent device or to an automated agent process. Geographic information may be derived from a variety of sources including, for example, vehicle license plate recognition performed by a camera associated with the interaction station, network location information associated with a device detected at the interaction station, historical interaction records associated with previously identified end users, or other location data associated with prior interaction sessions.

Using this geographic information, the system may determine that the detected end user is associated with a particular geographic region or cluster of users. In some implementations, the system maintains a database of historical interaction records that associate interaction outcomes and interaction modality selections with geographic regions. The computing system may analyze these historical interaction records to determine behavioral patterns associated with groups of users located within particular geographic clusters. For example, the system may determine that end users associated with a particular postal code, neighborhood, or region historically demonstrate a preference for interactions conducted with human-operated agents rather than automated agent processes.

When the system determines that the detected end user is associated with a geographic cluster exhibiting a historical preference for human-operated agents, the resource allocation engine may prioritize selection of a computing device operated by a human agent from the pool of available agent devices. The system may therefore select a human agent device instead of selecting an automated agent process, even when automated agents are available to service the interaction station. Once the human agent device is selected, the system establishes a communication session between the interaction station and the computing device associated with the selected human agent so that the human agent can interact with the end user through audio, video, or other communication channels supported by the system.

In some embodiments, the geographic clustering mechanism may also be used to determine when automated agent processes should be selected by default. For example, the historical interaction records associated with a geographic cluster may indicate that end users within a particular region frequently complete interaction sessions using automated agents or explicitly select automated agents when given a choice between interaction modalities. In such circumstances, the resource allocation engine may initially select an automated agent process executed by one or more computing systems connected to the distributed interaction system. The automated agent process may be implemented on computing infrastructure located at any network-accessible computing environment, including centralized data centers or distributed cloud computing systems.

The system may further allow the detected end user to override the predicted interaction modality determined from the geographic cluster analysis. For instance, an end user associated with a region that historically prefers automated agents may request interaction with a human agent through an input provided at the interaction station. In response to such input, the resource allocation engine may select a human-operated agent device from the pool of available agents and establish a communication session between the interaction station and the selected human agent device. Conversely, when an end user associated with a region that historically prefers human-operated agents indicates a preference for automated interaction, the system may initiate communication with an automated agent process. This dynamic allocation mechanism allows the system to incorporate both historical geographic interaction patterns and real-time user input when determining the most appropriate interaction modality.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method for dynamically allocating interaction resources within a distributed interaction system, the method comprising:
receiving, at one or more computing systems, video data from a sensing device associated with an interaction station;
processing the video data to detect an approaching end user and to extract one or more identity features associated with the end user;
determining, using the one or more computing systems, whether historical interaction data is associated with the detected identity features;
retrieving historical interaction records corresponding to the detected identity features when historical interaction data is determined to be associated with the end user;
executing, by the one or more computing systems, a prediction model configured to determine a preferred interaction modality for the end user based at least in part on the historical interaction records;
selecting, from a pool of available agent devices connected to the distributed interaction system, an interaction agent based on the preferred interaction modality determined by the prediction model, wherein the pool of available agent devices includes devices operated by human agents and automated agent processes executed by computing systems;
establishing a communication session between the interaction station and a computing device associated with the selected interaction agent; and
synchronizing contextual information derived from the historical interaction records to both:
(i) a display associated with the interaction station, and (ii) the computing device associated with the selected interaction agent.

2. The method of claim 1, wherein the identity features extracted from the video data include at least one of facial characteristics, vehicle characteristics, or license plate data associated with the approaching end user.

3. The method of claim 1, wherein the historical interaction records include records of previous interaction sessions associated with the detected identity features, the records including interaction outcomes, interaction duration metrics, and interaction preference indicators.

4. The method of claim 1, wherein selecting the interaction agent comprises selecting a computing device operated by a human agent based on a comparison between:
(i) attributes associated with the historical interaction records of the end user, and
(ii) attributes associated with a profile of the human agent, wherein the attributes associated with the human agent profile include one or more characteristics describing prior interactions between the human agent and end users.

5. The method of claim 4, wherein selecting the computing device operated by the human agent further comprises identifying historical interaction sessions in which the detected end user previously interacted with the human agent and determining whether those historical interaction sessions meet one or more interaction performance thresholds.

6. The method of claim 1, wherein selecting the interaction agent comprises selecting an automated agent process executed by one or more computing systems when the historical interaction records indicate that the end user has previously completed interaction sessions using automated agents.

7. The method of claim 6, wherein the automated agent process is selected when the historical interaction records indicate that previous interaction sessions with automated agents meet one or more interaction efficiency metrics.

8. The method of claim 1, wherein the prediction model determines the preferred interaction modality further based on behavioral patterns associated with a geographic cluster associated with the detected identity features.

9. The method of claim 8, wherein the geographic cluster is determined using location information associated with at least one of: vehicle registration data, network location data, or historical interaction locations.

10. The method of claim 1, wherein selecting the interaction agent further comprises selecting the agent based on compatibility between: (i) language preferences associated with the historical interaction records of the end user, and (ii) language capabilities associated with profiles of agents in the pool of available agent devices.

11. The method of claim 1, wherein selecting the interaction agent further comprises determining whether the selected agent device corresponds to an agent trained to support an interaction environment associated with the interaction station.

12. The method of claim 1, further comprising presenting, on the display associated with the interaction station, interface elements generated based on the historical interaction records associated with the detected identity features.

13. The method of claim 1, wherein synchronizing contextual information includes transmitting a representation of prior interaction selections associated with the end user to the computing device associated with the selected interaction agent.

14. A distributed interaction system comprising:
one or more interaction stations each comprising a sensing device configured to capture video data associated with an approaching end user and a display configured to present interface information;
one or more computing systems in communication with the one or more interaction stations; and
a resource allocation engine executed by the one or more computing systems and configured to:
process the video data received from the sensing device to detect the approaching end user and extract one or more identity features associated with the end user;
determine whether historical interaction data is associated with the extracted identity features;
retrieve historical interaction records corresponding to the identity features when historical interaction data is determined to be associated with the end user;
execute a prediction model configured to determine a preferred interaction modality for the end user based at least in part on the historical interaction records;
select, from a pool of available agent devices connected to the distributed interaction system, an interaction agent based on the preferred interaction modality determined by the prediction model, wherein the pool of available agent devices includes devices operated by human agents and automated agent processes executed by computing systems;
establish a communication session between the interaction station and a computing device associated with the selected interaction agent; and
synchronize contextual information derived from the historical interaction records to both the display of the interaction station and the computing device associated with the selected interaction agent.

15. The system of claim 14, wherein the sensing device comprises a camera configured to capture video data including facial characteristics, vehicle characteristics, or license plate data associated with the approaching end user.

16. The system of claim 14, wherein the resource allocation engine is further configured to select a computing device operated by a human agent based on a comparison between attributes associated with the historical interaction records of the end user and attributes associated with a profile of the human agent.

17. The system of claim 16, wherein the attributes associated with the human agent profile include one or more of language capabilities, training characteristics, or behavioral interaction traits associated with the human agent.

18. The system of claim 14, wherein the resource allocation engine is configured to select an automated agent process executed by one or more computing systems when the historical interaction records indicate that the end user has previously completed interaction sessions using automated agents.

19. The system of claim 18, wherein the automated agent process is selected when historical interaction records indicate that prior interaction sessions using automated agents meet one or more interaction efficiency metrics.

20. The system of claim 14, wherein the prediction model determines the preferred interaction modality further based on behavioral patterns associated with a geographic cluster associated with the end user.
